(19) United States
(12) Patent Application Publication
(10) Pub. No.: US 2022/0330555 A1
(43) Pub. Date: Oct. 20, 2022

(54) TEA TREE OIL FOR INDUCING SYSTEMIC RESISTANCE IN PLANTS

(71) Applicant: STOCKTON (ISRAEL) LTD., PETACH TIKVA (IL)

(72) Inventors: MOSHE REUVENI, KATZRIN (IL); DAPHNA BLACHINSKY, GAN YAVNE (IL)

(21) Appl. No.: 17/639,770

(22) PCT Filed: Aug. 26, 2020
(86) PCT No.: PCT/IL2020/050929

§ 371 Date: Mar. 2, 2022

(30) Foreign Application Priority Data
Sep. 3, 2019 (IL) 269116

(51) Int. Cl. A01N 65/28; A01N 25/04; A01N 25/16; A01N 63/12; A01N 63/20; A01N 63/30

(52) U.S. Cl. CPC A01N 65/28; A01N 25/04; A01N 25/16; A01N 63/12; A01N 63/20; A01N 63/30

(57) ABSTRACT

The present invention relates to inducing plant resistance to stress factors, including pathogens, draught and wounding, by application of Tea Tree Oil, or components thereof to plants. More specifically, the invention relates to a method for inducing defense response in a plant, comprising applying to a plant or a plant part, a composition comprising tea tree oil (TTO) or components thereof.

### FIELD OF THE INVENTION

The present invention relates to inducing plant defense responses. Specifically, the present invention relates to inducing plant resistance to stress factors, including pathogens, draught and wounding, by application of Tea Tree Oil, or components thereof to plants.

### BACKGROUND OF THE INVENTION

Plants have evolved highly effective mechanisms for resistance to disease caused by infectious agents, such as bacteria, fungi and viruses, as well as abiotic stress like wounds, draught and heat. Some of the plant responses to the biotic and abiotic stresses are limited to the infested damaged organ, but other responses systemically spread far from the infested organ and affect other organs or the whole plant. The latter includes induced resistance, which is a physiological state of enhanced defensive capacity of the plant triggered by biological or chemical inducers, which protects plant tissues that have not been exposed to the initial attack against future attack by pathogens. These latter responses include the Systemic Acquired Resistance (SAR) and the Induced Systemic Resistance (ISR). SAR is induced by pathogens and insects while ISR is mediated mainly by beneficial microbes living in the rhizosphere, like bacteria and fungi. These root-associated microbes, besides impacting on plant nutrition and growth, can further boost plant defenses, rendering the entire plant more resistant to pathogens and pests.

SAR and ISR are mainly differentiated on the basis of the elicitor and the regulatory pathways involved, though the signaling pathways that regulate SAR and ISR share some components. SAR is characterized by increased levels of the plant hormone salicylic acid (SA) which activates the expression of a large set of pathogenesis-related (PR) genes, involved in defense responses against biotic and abiotic stress. In contrast to SAR, ISR is generally mediated by an SA-independent pathway where Jasmonic acid (JA) requires signaling pathway followed by the ethylene signaling pathway and typically functions without PR gene activation.

Priming is a strategy used to improve the defensive capacity of plants, by activating the plant's defense mechanisms prior to stress. Such activation may include changes at the physiological, transcriptional, metabolic, and/or epigenetic levels. Thus, upon facing a subsequent challenge, the plant effectively mounts a faster and/or stronger defense response that results in increased resistance and/or stress tolerance. Priming can be durable and maintained throughout the plant's life cycle and can even be transmitted to subsequent generations, therefore representing a type of plant immunological memory.

Tea Tree Oil (TTO) is a natural essential oil characterized by a broad-spectrum antiseptic activity, and is known as an effective biocide against bacteria and fungi. TTO is extracted from the foliage and terminal branches of a cultivated plant Melaleuca alternifolia, native to Australia, New Zealand and Southeast Asia. TTO contains over 100 components, mostly monoterpenes, sesquiterpenes and their alcohols.

It is therefore an object of the present invention to provide methods and compositions comprising Tea Tree Oil (TTO) for inducing plant resistance mechanisms to stress factors.

Other objects and advantages of the invention will become apparent as the description proceeds.

### SUMMARY OF THE INVENTION

In one aspect, the present invention provides a method of inducing defense response in a plant, comprising applying to a plant or a plant part, a composition comprising tea tree oil (TTO) or components thereof.

According to one embodiment, the defense response is local or systemic acquired resistance (SAR). According to another embodiment, the defense response is induced systemic resistance (ISR). According to yet another embodiment, the defense response includes both induced systemic resistance (ISR) and local or systemic acquired resistance (SAR).

According to some embodiments of the invention, the defense response comprises induction of resistance imparting genes, overexpression of plant defense hormones, elevation of phenols and phenylpropanoids, and/or enhancement of pathogenesis related (PR) proteins enzymatic activity.

According to a specific embodiment, the plant defense hormones are selected from Salicylic acid (SA), Methyl salicylate (MeSA), Jasmonic acid (JA), Ethylene (ET), 1-aminoacyclopropane-1-carboxylate (ACC), jasmonoyl isoleucine (JA-Ile), and (−)-dihydrophaseic acid (DPA).

In another specific embodiment, the resistance imparting genes are selected from salicylate/benzoate carboxyl methyltransferase (BSMT1), nonrace-specific disease resistance protein 1 (NDR1), Rar1, heat shock protein 90 (HSP90), Enhanced disease susceptibility 1 (EDS1), EDS 5, Isochorismate synthase 1 (ICS1), ICS2, salicylic acid glucosyltransferase (UGT74F), methyl salicylate esterase (AtMES), phenylalanine ammonia-lyase (PAL), Salicylate/benzoate carboxyl methyltransferase (BSMT1), Non-expressor of PR1 (NPR1), Non-expressor of PR3 (NPR3), Pathogenesis-related protein 1 (PR1), Pathogenesis-related protein 2 (PR2), Pathogenesis-related protein 3 (PR3), Pathogenesis-related protein 4 (PR4), Phytoalexin Deficient 4 (PAD4), Senescence Associate Gene 101 (SAG101), TGACG motif binding transcription factors (TGA factors), WRKY transcription factors, 1-aminocyclopropane-1-carboxylate synthase (ACS), ACC oxidase (ACO), galactolipase/phospholipase A1 (DAD1), galactolipase (DGL), 13-Lipoxygenase (LOX2), allene oxide synthase (AOS), allene oxide cyclase (AOC), 12-oxo-phytodienoic acid reductase (OPR3), 3-oxo-2-[(Z)pent-2T-enyl]-cyclopentan-1-octanoic acid-Coenzyme A ligase (OPCL1), acyl-Coenzyme A oxidase (ACX), jasmonic acid-amino acid synthase (JAR1), jasmonic acid carboxyl methyltransferase (JMT), hydroxyjasmonic acid sulfotransferase (AtST2a), Coronatine-insensitive protein 1 (COI1), jasmonate-zim-domain protein 1 (JAZ1), bHLHzip transcription factor MYC2 (MYC2), Ethylene response factor 1 (ERF1), and Ethylene insensitive 3 (EIN3), HCR2, CCNBS, TIR-NBS, RRL, and RESIS.

In some embodiments of the invention, inducing of defense response comprises the priming of the resistance mechanisms of the plant.

In other embodiments, the defense response is activated in the event of an attack by a pathogen or pest. According to a specific embodiment, the pathogen or pest is a fungus, an oomycete, a bacterium, a virus, an insect, a protozoa, a nematode or an acarus. In another specific embodiment,

In further embodiments, the defense response is activated in the event of abiotic stress. According to a specific embodiment, the abiotic stress is drought, wounding, mechanical wounding, cold exposure, heat exposure, osmotic stress, UV light exposure, flooding, increased soil salinity, increased mineral exposure, ozone exposure, high light exposure, or limited availability of nutrients.

In an embodiment of the above method, TTO is applied to the plant or plant part before or after exposure of the plant to a biotic or abiotic stress, or to an asymptomatic plant or a plant showing a symptom of stress or disease.

According to one embodiment of the invention, TTO or a composition comprising TTO or components thereof is applied to the plant by drenching, foliar or soil spraying, dipping, watering, aerial or drip irrigating, evaporating, dusting, fogging, foaming, spreading-on, or injecting.

According to some embodiments, the inducing of defense response in the plant results in a stronger and faster induction of the expression of plant defense genes in the event of biotic or abiotic stress, as compared to non-treated plants.

In another aspect, the present invention provides a method of inducing expression of defense genes in a plant or a plant part, comprising applying to the plant or the plant part, a composition comprising tea tree oil (TTO) or components thereof.

In a further aspect, the invention relates to a method of activating salicylic acid (SA)-, jasmonic acid (JA)-, and/or ethylene- mediated resistance, in a plant or a plant part, comprising applying to the plant or the plant part a composition comprising tea tree oil (TTO) or components thereof.

According to one embodiment of the above-mentioned methods, TTO is applied in combination with at least one additional compound, selected from the group consisting of a plant growth regulator, a plant nutrient, a pesticide, an insecticide, a fungicide, a bactericide, an herbicide, an acaricide, and a nematicide.

### BRIEF DESCRIPTION OF THE DRAWINGS

FIGS. 1A-1D show the induction of pathogenesis-related (PR) proteins enzymatic activity by TTO in root extracts of banana plants inoculated with Fusarium oxysporum f.sp. cubense (Foc) tropical race 1 or 3 (Foc TR1 or Foc TR3, respectively).

FIG. 1A shows the enzymatic activity (EA) of guaiacol peroxidase in root extracts from untreated plants (control, C) or plants pre-treated with TTO at 5, 10 or 15 days prior to inoculation with Fusarium oxysporum (TTO 5, TTO 10 and TTO 15, respectively). The enzymatic activity is expressed as the difference in optical density at 470 nm per 1 minute per 1 mg total protein (AOD/min/mg).

FIG. 1B shows the enzymatic activity (EA) of β-1,3-Glucanase in root extracts from untreated plants (control, C) or plants pre-treated with TTO at 5, 10 or 15 days prior to inoculation with Fusarium oxysporum (TTO 5, TTO 10 and TTO 15, respectively). The enzymatic activity is expressed as μg of glucose produced from laminarin per 1 minute per 1 mg total protein (μg/min/mg).

FIG. 1C shows the content of free phenols in root extracts from untreated plants (control, C) or plants pre-treated with TTO at 5, 10 or 15 days prior to inoculation with Fusarium oxysporum (TTO 5, TTO 10 and TTO 15, respectively). The phenol content is expressed as arbitrary absorbance units (AU).

FIG. 1D shows the cell wall bound phenol content in root extracts from untreated plants (control, C) or plants pre-treated with TTO at 5, 10 or 15 days prior to inoculation with Fusarium oxysporum (TTO 5, TTO 10 and TTO 15, respectively). The cell wall bound phenol content in untreated plants that were not inoculated with Fusarium oxysporum (C/N) is also shown. The phenol content is expressed as arbitrary absorbance units (AU).

FIGS. 2A-2C show the induction of pathogenesis-related (PR) proteins enzymatic activity by TTO in root extracts of pre-treated banana plants further treated or untreated with TTO that were grown in Fusarium infested soil (Foc TR4).

FIG. 2A shows the enzymatic activity (EA) of guaiacol peroxidase in root extracts from untreated plants (control, C) or plants further treated with TTO. The enzymatic activity is expressed as the difference in optical density at 470 nm per 1 minute per 1 mg total protein (AOD/min/mg). *p<0.05.

FIG. 2B shows the enzymatic activity (EA) of β-1,3-Glucanase in root extracts from untreated plants (control, C) or plants further treated with TTO. The enzymatic activity is expressed as μg of glucose produced from laminarin per 1 minute per 1 mg total protein (μg/min/mg). *p<0.05.

FIG. 2C shows the total protein content (PC) in root extracts from untreated plants (control, C) or plants further treated with TTO, expressed in mg equivalents of bovine serum albumin (BSA) per 1 g sample (mg/g), as determined based upon standard curve of BSA.

FIGS. 3A-3B show the gene expression profile of SAR- and ISR-related genes in banana plants. FIG. 3A shows the fold change (FC) in the expression of the SAR-related genes: NPR1, PR1, PR2, PR3 and BSMT1 in TTO-treated asymptomatic plants (TA), plants showing symptoms of Fusarium Wilt (CS) and TTO-treated and symptomatic plants (TS) relative to untreated asymptomatic plants (CA).

FIG. 3B shows the fold change (FC) in the expression of the ISR-related genes: MYC2, ACS and ERF1 in TTO-treated asymptomatic plants (TA), plants showing symptoms of Fusarium Wilt (CS) and TTO-treated and symptomatic plants (TS) relative to untreated asymptomatic plants (CA).

FIGS. 4A-4B show the effect of TTO treatment on bacterial leaf spot in tomato plants inoculated with Xanthomonas campestris.

FIG. 4A shows the percent severity of the bacterial leaf spot on tomato plants leaves inoculated with Xanthomonas campestris treated or untreated with TTO (+TTO or −TTO, respectively) at various days post inoculation (dpi).

FIG. 4B shows the Area Under Disease Progress Curve (AUDPC) demonstrating the progress of bacterial leaf spot severity in tomato plants inoculated with Xanthomonas campestris, which are treated or untreated with TTO (+TTO or −TTO, respectively).

FIGS. 5A-5C show the effect of TTO on levels of salicylic acid and jasmonic acid in leaves of pepper plants.

FIG. 5A shows the levels (in parts per million, ppm) of salicylic acid (SA) and jasmonic acid (JA) in leaves from pepper plants at the vegetative stage grown under normal irrigation, at 1 day post application of TTO (Timorex Gold®, 1 L/ha) or in untreated plants (control, C).

FIG. 5B shows the levels of (in parts per million, ppm) of salicylic acid in samples of the youngest full leaf from pepper plants at the vegetative stage grown under normal irrigation after two applications of TTO (Timorex Gold®, 1 L/ha) or in untreated plants (control, C).

FIG. 5C shows the levels of (in parts per million, ppm) of salicylic acid in samples of the youngest full leaf from pepper plants at the vegetative stage grown under drought condition after two applications of TTO (Timorex Gold®, 1 L/ha) or in untreated plants (control, C).

### DETAILED DESCRIPTION OF THE INVENTION

It has now been found that tea tree oil (TTO) is capable of inducing plant defense pathways against damages caused by biotic and abiotic stresses. The compositions comprising TTO according to the invention thus efficiently serve as natural resistance elicitors, exhibiting remarkable beneficial effects when applied to the plant either before or after the plant has encountered the stress.

In particular, the inventors surprisingly found that application of TTO to plants (such as banana, avocado, tomato and pepper plants), either alone or in the presence of a challenge, including pathogens, mechanical wounds or drought conditions, activates several pathogenesis related (PR) proteins known to play a role in defense mechanism, as well as induces the expression of genes associated with systemic resistance pathways, i.e., systemic acquired resistance (SAR) and induced systemic resistance (ISR) pathways. Specifically, TTO induces the accumulation of jasmonic acid (JA), ethylene and/or salicylic acid in plants, thereby activating defense responses and providing the plant with increased resistance and/or stress tolerance.

The term “plant” as used herein refers to all plants and plant populations, crops and cultivars.

The term “plant parts” refers to is meant all physical parts and organs of plants, including saplings, roots, tubers, stems, stalks, shoot, leaves, blossoms, foliage, and fruits.

Induced resistance refers to activation of plant defense responses by biotic or abiotic elicitors. The resistance is expressed locally or systematically.

The induced systemic resistance elicited by TTO according to the present invention can start as a local acquired resistance in the treated plant or plant part and result in a systemic acquired resistance (SAR) by spreading out throughout the whole plant.

The systemic acquired resistance (SAR) and the induced systemic resistance (ISR) that are induced by TTO protect all, including newly grown parts of the plant, and even subsequent generations, irrespective to the plant part which was treated directly with TTO. For example, spraying banana foliage with TTO results in induction of resistance it the plant's roots, and also in the banana's daughter plants. Similarly, application of TTO to Avocado trees by soil drenching exerts protection in the foliage and branches of Avocado plant.

In one embodiment of the present invention, the defense responses are local or systemic defense responses of the plant, including local or systemic acquired resistance (SAR), which are activated following exposure to pathogens or wounding via the salicylic acid pathway. SAR is associated with the massive systemic induction of a wide range of anti-pathogen genes including “pathogenesis-related” proteins (PR proteins). This activation requires the accumulation of endogenous salicylic acid (SA) and intact SA cellular signaling and can be associated with hypersensitive response or cell death.

In another embodiment of the present invention, the defense response is induced systemic resistance (ISR), which is induced following root colonization by rhizobacteria via jasmonic acid/ethylene pathways. Prior interaction with pathogens is not a requirement for ISR. For example, interaction with symbiotic fungi and bacteria that colonize roots (by nonpathogenic rhizosphere bacteria) can induce ISR. In contrast to SAR, ISR is not necessarily SA-dependent, but usually requires components of the jasmonic acid (JA) signaling pathway, followed by the ethylene signaling pathway.

It should be noted that TTO may elicits various types of induced resistance in different plants. For example, TTO can induce SAR, ISR, or both in the same plant.

In another embodiment of the present invention, the treatment of the plant, or plant parts with TTO induces the expression of defense genes in the plant.

In one specific aspect of the invention, the defense responses inducted by TTO comprise the priming of the intrinsic disease resistance mechanisms of a plant, also known as plant immune response.

The priming causes the plant to activate its resistance mechanisms, in a stronger and faster way upon an attack by a pathogen or pest or abiotic stress, and ensures that the resistance mechanisms are activated in time for protection. The use of TTO according to the invention effectively serves as an early warning system, enabling the plant to rapidly activate defense responses in an attempt to control the attack.

The present invention shows that TTO can prime plants against a wide range of plant pathogens and abiotic stresses. TTO-induced plant resistance may have variable pathways. The mode of action can be independent of jasmonic acid (JA), salicylic acid (SA) and ethylene signaling pathways, by enhancing multiple pathways. TTO may enhance resistance by priming the appearance of PR proteins, such as antifungals (e.g., chitinases and glucanases) and oxidative enzymes (e.g., peroxidases, polyphenol oxidases and lipoxygenases), or enhancing callose deposition or lignification.

In one aspect, the application of TTO according to the present invention induces the expression of resistance imparting (defense) genes, as well as enhances the enzymatic activity of PR proteins.

The plant genes, proteins and/or hormones associated with the systemic acquired resistance (SAR) pathway that may be induced according to the invention are selected from the group consisting of: Salicylic acid (SA); Methyl salicylate (MeSA); salicylate/benzoate carboxyl methyltransferase (BSMT1); nonrace-specific disease resistance protein 1 (NDR1); Rar1; heat shock protein 90 (HSP90); Enhanced disease susceptibility 1 (EDS1); EDS 5; Isochorismate synthase 1 (ICS1); ICS2; salicylic acid glucosyltransferase (UGT74F); methyl salicylate esterase (AtMES); phenylalanine ammonia-lyase (PAL); Salicylate/benzoate carboxyl methyltransferase (BSMT1); Non-expressor of PR1 (NPR1); Non-expressor of PR3 (NPR3); Pathogenesis-related protein 1 (PR1); Pathogenesis-related protein 2 (PR2); Pathogenesis-related protein 3 (PR3); Pathogenesis-related protein 4 (PR4); Phytoalexin Deficient 4 (PAD4); Senescence Associate Gene 101 (SAG101); TGACG motif binding transcription factors (TGA factors) and WRKY transcription factors.

The plant genes, proteins and/or hormones associated with the induced systemic resistance (ISR) pathway that may be induced according to the invention are selected from the group consisting of: Jasmonic acid (jasmonate, JA); Ethylene (ET); 1-aminoacyclopropane-1-carboxylate (ACC); 1-aminocyclopropane-1-carboxylate synthase (ACS); ACC oxidase (ACO); galactolipase/phospholipase A1 (DAD1); galactolipase (DGL); 13-Lipoxygenase (LOX2); allene oxide synthase (AOS); allene oxide cyclase (AOC); 12-oxo-phytodienoic acid reductase (OPR3); 3-oxo-2-[(Z)pent-2′-enyl]-cyclopentan-1-octanoic acid-Coenzyme A ligase (OPCL1); acyl-Coenzyme A oxidase (ACX); jasmonic acid-amino acid synthase (JAR1); jasmonic acid carboxyl methyltransferase (JMT); hydroxyjasmonic acid sulfotransferase (AtST2a); Coronatine-insensitive protein 1 (COI1); jasmonate-zim-domain protein 1 (JAZ1); bHLHzip transcription factor MYC2 (MYC2); Ethylene response factor 1 (ERF1); and Ethylene insensitive 3 (EIN3).

Additional genes or proteins that may be induced according to the invention are resistance genes (R-Genes), such as HCR2, CCNBS, TIR-NBS, RRL, and RESIS; and pathogenesis-related protein (PR-Proteins), such as guaiacol peroxidase, β-1,3-Glucanase.

Furthermore, the present invention induces elevation in phenol content in the plant's cells, which serves as an important defense mechanism against pathogen infection. Elevation in phenol content in plant cells, and activation of enzymes involved in phenols synthesis and localization within the cell, are indicators for activation of defense response.

TTO application according to the invention further upregulates the synthesis of phenylpropanoids, which are a diverse family of organic compounds that serve as essential components of a number of structural polymers, provide protection from ultraviolet light, defend against herbivores and pathogens, and mediate plant-pollinator interactions as floral pigments and scent compounds.

Accordingly, the defense response elicited by application of TTO comprises induction of resistance imparting genes, overexpression of plant defense hormones, elevation of phenols and phenylpropanoids, and/or enhancement of pathogenesis related (PR) proteins enzymatic activity.

Non-limiting examples of plant defense hormones are Salicylic acid (SA), Methyl salicylate (MeSA), Jasmonic acid (JA), Ethylene (ET), 1-aminoacyclopropane-1-carboxylate (ACC), jasmonoyl isoleucine (JA-Ile), and (−)-dihydrophaseic acid (DPA).

Non-limiting examples of resistance imparting genes are salicylate/benzoate carboxyl methyltransferase (BSMT1), nonrace-specific disease resistance protein 1 (NDR1), Rar1, heat shock protein 90 (HSP90), Enhanced disease susceptibility 1 (EDS1), EDS 5, lsochorismate synthase 1 (ICS1), ICS2, salicylic acid glucosyltransferase (UGT74F), methyl salicylate esterase (AtMES), phenylalanine ammonia-lyase (PAL), Salicylate/benzoate carboxyl methyltransferase (BSMT1), Non-expressor of PR1 (NPR1), Non-expressor of PR3 (NPR3), Pathogenesis-related protein 1 (PR1), Pathogenesis-related protein 2 (PR2), Pathogenesis-related protein 3 (PR3), Pathogenesis-related protein 4 (PR4), Phytoalexin Deficient 4 (PAD4), Senescence Associate Gene 101 (SAG101), TGACG motif binding transcription factors (TGA factors), WRKY transcription factors, 1-aminocyclopropane-1-carboxylate synthase (ACS), ACC oxidase (ACO), galactolipase/phospholipase A1 (DAD1), galactolipase (DGL), 13-Lipoxygenase (LOX2), allene oxide synthase (AOS), allene oxide cyclase (AOC), 12-oxo-phytodienoic acid reductase (OPR3), 3-oxo-2-[(Z)pent-2T-enyl]-cyclopentan-1-octanoic acid-Coenzyme A ligase (OPCL1), acyl-Coenzyme A oxidase (ACX), jasmonic acid-amino acid synthase (JAR1), jasmonic acid carboxyl methyltransferase (JMT), hydroxyjasmonic acid sulfotransferase (AtST2a), Coronatine-insensitive protein 1 (COI1), jasmonate-zim-domain protein 1 (JAZ1), bHLHzip transcription factor MYC2 (MYC2), Ethylene response factor 1 (ERF1), and Ethylene insensitive 3 (EIN3), HCR2, CCNBS, TIR-NBS, RRL, and RESIS.

In another aspect, the invention provides a method of activating salicylic acid (SA)-, jasmonic acid (JA)-, and/or ethylene-mediated resistance, in a plant or a plant part, comprising applying to the plant or the plant part a composition comprising tea tree oil (TTO) or components thereof.

It should be noted the TTO can be applied to the plant or plant part before or after exposure to a biotic or abiotic stress. In addition, TTO can be applied to asymptomatic plants or plants showing a symptom of stress or disease. Furthermore, TTO can be applied to an infected or non-infected plant.

The term “symptom of stress or disease” as used herein refers to any indication of reduction in the plant's vigor, which includes but is not limited to stains, wilt, color alteration, decreased growth rate, underdevelopment of young leaves.

Particularly, the beneficial effect of the present invention is demonstrated herein for the following diseases and conditions: (a) fusarium wilt disease caused by the fungus Fusarium oxysporum f.sp. cubense (FOC) in banana; (b) bacterial leaf spot caused by the bacterium Xanthomonas campestris in tomato; (c) mechanical wounding in tomato; (d) drought in pepper; and (e) the disease “regressive death” or “black arm” caused by the fungus Lasiodiplodia theobromae in avocado.

While this description specifically makes reference to TTO, the skilled person will understand that fractions of TTO, comprising components thereof and/or components in different proportions, will be effective in various degrees. Accordingly, whenever reference is made to “TTO” it should be understood to include also compositions comprising TTO components as well known in the art, and also selected from those listed in Table 1 below:

TABLE 1
Components

α-pinene
sabinene
α-terpinene
limonene
p-cymene
1,8 cineole
γ-terpinene
α-terpinolene
terpinen-4-ol
α-terpineol
aromadendrene
ledene
δ-cadinene
globulol
viridiflorol

The contents of the various components of a standard TTO composition are detailed in ISO 4730:2017.

Since some compounds existing in TTO are minor in activity and/or percentage, it will be clear to a skilled person that it is possible to apply components of TTO that do not include such minor compounds to carry out the invention.

The present invention provides a composition comprising TTO, wherein the TTO concentration is from about 5% to about 70% (weight percent), based on the total weight of the composition.

Further to the active agent, the composition according to the invention may comprise any suitable solvent, surfactant, emulsifier, and neutralizer. In general, the composition according to the invention may include from 5% to 70% by weight of the active agent TTO, from 40% to 95% solvent, from 0 to 10% surfactant, from 0 to 10% neutralizer, and from 0 to 50% emulsifier.

Specifically, the TTO encompassed by the present invention is e.g., a water-in-oil or an oil-in-water emulsion, which is non-phytotoxic.

According to one embodiment, the TTO composition used for inducing resistance to stress conditions in plants is a water-in-oil emulsion, wherein the TTO concentration applied is from 0.05 ppm to 500 ppm (w/w), based on the total weight of the treated volume. In some embodiments, when applied in the field, e.g. by spray or soil drenching, the composition comprises TTO in an amount of from 50 ppm to 500 ppm. In other embodiments, wherein the composition comprising TTO is applied to growth medium, the TTO concentration is from 0.05 ppm to 0.2 ppm. Compositions comprising these concentrations of TTO were found to elicit resistance, without inducing phytotoxicity in the treated tissue.

Of note, the present invention allows the application of a composition comprising low amounts of TTO, which is sufficient to induce the beneficial effect on the treated plants.

The plants or plant parts according to the invention can be treated with a composition comprising TTO at any frequency, for examples one time or more, such as 2 times, 3 times, 4 times, 5 times or more. The time interval between two treatments can be chosen according to the agronomical needs. For example, TTO may be applied every three days, once a week, once a month, or once a year. According to a specific embodiment, the treatment is supplemented by additional applications on various days. It should be noted that the plant may be treated with the composition comprising TTO according to the invention for any desired period of time.

In another embodiment, the plant itself is not treated, and is planted in a medium or soil that was exposed to a composition comprising TTO prior to the planting. In a further embodiment, the medium or soil are treated with a composition comprising TTO prior to the planting of the plant, and later the composition comprising TTO is applied to the plant, plant tissue, plant portion, growth medium or soil.

According to the invention, the composition comprising TTO is applied to the plant at any stage of its life cycle, including tissue culture, plantlet before or after hardening, vegetative growth, flowering, and fruiting.

Thus, the invention encompasses the application of a composition comprising TTO to any portion or part of the plant, including the foliage or roots, to the meristem tissue before it is planted, or to media in which the plants are grown or are to be planted (such as soil).

The composition comprising TTO according to the invention is applied as a liquid solution by drenching, foliar or soil spraying, dipping, watering, aerial or drip irrigating, evaporating, dusting, fogging, foaming, spreading-on, or injecting. In a specific embodiment, the composition comprising TTO is applied directly to soil or tissue culture growth medium.

The composition comprising TTO may further comprise any additional acceptable substances, including but not limited to plant growth regulators, plant nutrients, pesticides, insecticides, fungicides, bactericides, herbicides, acaricides, and nematicides.

Notably, TTO can be used as the sole active agent, or in combination with at least one additional compound, selected, for example, from plant growth regulators, plant nutrients, pesticides, insecticides, fungicides, bactericides, herbicides, acaricides, and nematicides. The at least one additional compound can be either a synthetic product or a biological product, such as a biopesticide.

Typical devices for applying an effective amount of composition comprising TTO to the soil include a gravity flow applicator, e.g., chisel, tooth or shank type applicators; commercially available sprayers, atomizers, aerators, blowguns, low pipes; pulverizes or the like are also provided as useful applicators. Irrigating means, such as drip emitters, micro sprayers, emitter tubing, misters and the like are useful applicators. Other methods of delivery useful according to the present invention include encapsulation, micro-encapsulation or any commercially available techniques of controlled release of flowing matter.

The use of TTO according to the invention in both organic and conventional agriculture represents a major step in assisting with controlling plant diseases and managing stress.

Treatment of TTO according to the present invention provides improved tolerance and increases the plant's resistance to stress factors. This means that certain traits are improved qualitatively or quantitatively when compared with the same trait in a control plant which has been grown under the same conditions in the absence of TTO application according to the invention.

Such traits include, but are not limited to, an increased tolerance and/or resistance to abiotic stress factors which cause sub-optimal growth conditions such as drought (e.g. any stress which leads to a lack of water content in plants, a lack of water uptake potential or a reduction in the water supply to plants), wounding (e.g. mechanical wounding), cold exposure, heat exposure, osmotic stress, UV light exposure, flooding, increased soil salinity, increased mineral exposure, ozone exposure, high light exposure, and/or limited availability of nutrients (e.g. nitrogen and/or phosphorus nutrients). A plant with improved resistance to stress factors may have an increase in any of the aforementioned traits or any combination of two or more of the aforementioned traits.

The term “wounding” or “wound” as used herein refers to any cut or breach in any part of the plant that involves laceration, perforation, cracking or breaking of the outer layer of the plant or plant part, and may also include damage to underlying tissues. The wounding may occur due to an external agent, which is a biotic stressor (such as birds, pests and insects) or an abiotic stressor (such as drought, sub-optimal humidity or temperature, impaired accumulation of soluble solids and impaired calcium nutrition).

Non-limiting examples of biotic stresses include pathogens or pests, e.g. fungi, oomycetes, bacteria, viruses, insects, protozoa, nematodes or acari. The biotic stresses according to the invention may include: Fusarium oxysporum; Xanthomonas campestris; Lasiodiplodia theobromae; Soybean mosaic virus; Clover yellow vein virus; Turnip mosaic virus; Bean Yellow Dwarf Virus; Beet Severe Curly Top Virus; Citrus Tristeza Virus; Mungbean Yellow Mosaic India Virus; Potato virus Y; Plantago Asiatica Mosaic Virus; Turnip Crinckle virus; Bean common mosaic virus; Bean necrotic mosaic virus; Blackeye cowpea mosaic virus; Azuki mosaic virus; Cowpea aphid-borne mosaic virus; Passionfruit woodiness virus; Thailand Passiflora virus; Watermelon mosaic virus; Zucchini yellow mosaic virus; Tobacco Etch Virus; Tobamovirus; Lettuce Mosaic Virus; Tobacco mosaic virus; Begomovirus; Rice yellow mottle virus; Sugarcane Mosaic Virus; Pea seed-borne mosaic virus; Tobacco vein mottling virus; Zucchini yellow mosaic virus; Tomato yellow leaf curl virus; Papaya ring-spot virus; Cucumber mosaic virus; Pepper Veinal Mottle Virus; Bean Dwarf Mosaic Virus; Potato virus X; Barley yellow mosaic virus; Barley mild mosaic virus; Beet Necrotic Yellow Vein Virus; Bean yellow mosaic virus; Pepper mottle virus; Rice Stripe Virus; Tomato spotted wilt virus; Tomato Mosaic Virus; Phytophthora capsici; Phytophthora sojae; Phytophthora infestans; Albugo candida; Bremia lactucae; Hyaloperonospora arabidopsidis; Phytophthora parasitica; Meloidogyne incognita; Globodera rostochiensis; Heterodera avenae; Heterodera glycines; Heterodera schachtii; Globodera pallida; Meloidogyne; Nilaparvata lugens; Bemisia tabaci; Aphis gossypii; Callosobruchus chinensis; Diabrotica virgifera; Manduca sexta; Macrosiphum euphorbiae; Cladosporium fulvum (Syn. Passalora fulva); Magnaporthe oryzae; Alternaria alternata; Botrytis cinerea; Sclerotinia sclerotorium; Erysiphe cichoracearum (Syn. Golovinomyces cichoracea rum); Phakopsora pachyrhizi; Alternaria brassicicola; Blumeria graminis; Golovinomyces orontii; Verticillium dahliae; Cercospora zeae-maydis; Cercospora zeina; Cochliobolus heterostrophus; Setosphaeria turcica; Cochliobolus carbonurn; Venturia inaequalis; Exserohilum turcicum; Melampsora lini; Trichoderma viride; Leptosphaeria maculans; Cochliobolus victoriae; Puccinia triticina; Puccinia striiformis; Puccinia graminis; Erysiphe graminis; Diplocarpon rosae; Heterobasidion parviporum; Pantoea stewartii; Setosphaeria turcica (Syn. Exserohilum turcicum); Periconia circinata; Magnaporthe grisea; Bipolaris maydis; Fusarium graminearum; Aspergillus niger; Glomerella graminicola ((Syn. Colletotrichum graminicola); Colletotrichum trifolii; Pyrenophora graminea; Alternaria brassicae; Puccinia sorghi; Colletotrichum higginsianum; Golovinomyces cichoracearum; Stagonospora nodorum; Zymoseptoria tritici; Cercospora beticola; Puccinia recondita; Sclerotinia sclerotiorum; Sclerotium rolfsii; Moniliophthora perniciosa; Pyrenophora tritici-repentis; Sphacelotheca reiliana; Pseudomonas syringae; Xanthomonas axonopodis; Xanthomonas gardneri; Ralstonia solanacearum; Xanthomonas oryzae; Xanthomonas citri; Xanthomonas perforans; Xanthomonas fuscans; Xanthomonas gardneri; Xanthomonas arboricola; Pseudomonas savastanoi; and Burkholderia andropogonis.

It should be appreciated that treatment of plants with TTO, in the absence of a stress factor, does not harm the growth or vitality of the plant, as characterized for example by crop yield, leaf size, plant height or weight, or any other features known to a person skilled in the art.

The present invention allows that application of TTO, or components thereof, to any crop plant, in particular monocotyledons such as cereals (wheat, millet, sorghum, rye, triticale, oats, barley, teff, spelt, buckwheat, fonio and quinoa), rice, maize (corn), and/or sugar cane; palm trees, banana or dicotyledon crops such as beet; fruits (for example apples, pears, plums, peaches, almonds, cherries, strawberries, raspberries or blackberries); leguminous plants (such as beans, soybeans, lentils, or peas); oil plants (such as rape, mustard, poppy, olives, sunflowers, coconut, castor oil plants, cocoa beans or groundnuts); cucumber plants (such as marrows, cucumbers or melons); fibre plants (such as cotton, flax, hemp or jute); citrus fruit (such as oranges, lemons, grapefruit or mandarins); vegetables (such as tomatoes, pepper, spinach, lettuce, cabbages, carrots, potatoes, or cucurbits); lauraceae (such as avocados, cinnamon or camphor); bananas; tobacco; nuts; coffee; tea; vines; hops; durian; natural rubber plants; and ornamentals (such as flowers, shrubs, broad-leaved trees or evergreens).

The compositions comprising TTO or components thereof according to the present invention mat further comprise one or more agriculturally suitable carriers, extenders (such as water) and surfactants. According to the invention, a carrier is a natural or synthetic, organic or inorganic substance which is mixed or combined with TTO for better applicability to plants. The carrier, which may be solid or liquid, is generally inert and is suitable for use in agriculture.

In another aspect, the present invention relates to a method of treating a plant or a plant part with a composition comprising TTO for inducing resistance to stress in the plant.

More specifically, the present invention relates to a method of treating a plant or a plant part with a composition comprising TTO for inducing defense responses in the plant. In one embodiment of the present invention, the defense response is local or systemic acquired resistance (SAR). In another embodiment, the defense response is induced systemic resistance (ISR). In a further embodiment, TTO induces both SAR and ISR in the same plant.

The present invention further relates to a method of treating a plant or a plant part with a composition comprising TTO for inducing accumulation of jasmonic acid (JA), salicylic acid (SA) and/or ethylene, in the plant. The present invention therefore also relates to a method of treating a plant or a plant part with a composition comprising TTO for inducing expression of defense genes in the plant.

The invention will now be described with reference to specific examples and materials. The following examples are representative of techniques employed by the inventors in carrying out aspects of the present invention. It should be appreciated that while these techniques are exemplary of specific embodiments for the practice of the invention, those of skill in the art, in light of the present disclosure, will recognize that numerous modifications can be made without departing from the spirit and intended scope of the invention.

### EXAMPLES

Materials and methods

### Evaluation of the Incidence of Fusarium Wilt on Daughter Banana Plants

In one field experiment, banana plants affected by Fusarium Wilt, caused by Fusarium oxysporum f. sp. cubense (Foc) of tropical race 1 or 3 (Foc TR1 or Foc TR3, respectively), were treated with TTO (in the form of Timorex Gold® (comprising 222.5 g/L TTO) applied at 0.6 L/ha)) or Nativo®, a premixed fungicide containing tebuconazole and trifloxystrobin (applied at 0.5 L/ha). Treatments included 4 applications of the materials to the leaves of the plants by spraying, at monthly intervals. Evaluation of Fusarium Wilt-positive or negative daughter plants was performed visually, at one year after the first application of treatments by an incision in the trunk of the daughter plants.

In a second field experiment, banana plants affected by Fusarium Wilt (Foc TR1 or Foc TR3) were treated with a triazole-based treatment (comprising propiconazole in the form of Tilt° or difenoconazole in the form of Score° at 450 mL/ha and the two physio activators Biozyme° and Kfol®) or a TTO-based treatment (comprising TTO in the form of Timorex Gold® at 0.6 L/ha and the two physio activators Biozyme® and)Kfol®. It should be noted that physio activators serve to increase the amount and quality of fruit produce rather than treating plant infections. The treatments involved five applications of the materials to the leaves of the plants by spraying at about 1.5-2.0-month intervals. A first evaluation of the incidence of daughter banana plants affected by Fusarium Wilt, took place about one year after first application of the treatments, and a second evaluation was carried out about two years after first application of the treatments.

Inoculation Of Banana Plants with Fusarium oxysporum f. sp. Cubense (Foc)

Conidial suspension containing 1×10⁶ spores/mL of Foc was used. Inoculation was carried out by wounding the plants' roots by shovel, and applying 200 ml of Foc at 1×10⁶ spores/mL.

### Preparation of Root Samples

In one experiment, banana plants were pre-treated with TTO (in the form of Timorex Gold®) 5, 10, or 15 days prior to inoculation with Fusarium oxysporum f.sp. cubense (Foc) tropical race 1 or 3 (Foc TR1 or Foc TR3, respectively). Thirty days after inoculation, roots were separated from leaves and were submerged in liquid nitrogen until the formation of powder. Then sodium phosphate buffer (100 mM, pH 7.5) was added and the samples were centrifuged at 20,000 g for 30 minutes at 4° C. The supernatant was collected and used to perform the biochemical analyses described below, while kept on ice.

In a second experiment, young banana plants of “Gal” (a tolerant variety) were grown in a greenhouse, and at 6-8 leaf stage were planted in a “hot spot” area, where the soil was contaminated with Foc TR4 in 10 rows (90 plants per row). Rows 1-5 were not treated (control), while rows 6-10 were sprayed with TTO (in the form of Timorex Gold® at 5 ml/L) every second week. Root samples were extracted as indicated above from the plants.

### Guaiacol Peroxidase Enzymatic Activity Assay

The activity of guaiacol peroxidase was determined in a reaction mixture consisting of 2.9 mL of the reaction buffer (10 mM sodium phosphate buffer at pH 7.5, 2.3 mM guaiacol and 2.9 mM H₂O₂] and 0.1 mL of the plant extract. The conversion of guaiacol to tetra-guaiacol by guaiacol peroxidase was monitored spectrophotometrically at 470 nm during 1 minute, at 15 seconds intervals.

### β-1,3-Glucanase Enzymatic Activity Assay

The activity of β-1,3-Glucanase was determined by the quantification of glucose released from laminarin as a substrate. 150 μL of the plant extract was mixed with 150 μL of 0.2% laminarin dissolved in 10 mM sodium phosphate buffer (pH 7.5). The reaction mixture was incubated at 37° C. for 3 hours. 1.5 mL of p-hydroxybenzoic acid hydrazide (PAHBAH) was added to the incubated reaction mixtures. The reaction was terminated by heating at 100° C. for 10 minutes. A negative control sample was prepared by incubating the plant extract for 3 hours (without laminarin) followed by addition of laminarin immediately before the termination of the reaction. Glucose concentration was determined spectrophotometrically at 410 nm. The results obtained in the negative control were subtracted from the results of the tested samples in order to determine the glucose content released from laminarin independently from basal levels of glucose in the root samples, namely to determine the enzymatic activity of β-1,3-Glucanase.

### Phenol Content Determination

The content of free phenols and cell wall bound phenols in the root extracts was determined by a conventional spectrophotometric method, well known in the art. Absorbance was measured at 750 nm.

### Total Protein Content Determination

The total protein content in the root extracts was quantified based upon the Bradford assay. 800 μL of root extract was mixed with 200 μL of the Bradford reagent. After 5 minutes, the absorbance was determined spectrophotometrically at 595 nm.

Inoculation of Tomato Plants with Xanthomonas campestris

The bacterium was grown in Nutrient-Agar (NA) medium, which consists of: 2 g yeast extract; 5 g peptone; 5 g sodium chloride and 15 g agar. The inoculum was grown in a Bio-Oxygen Demand (B.O.D.) incubator at 28° C. in the dark for about 24 hours, in which the bacteria was at a high rate of multiplication.

Top Seed Italian tomato variety tomato seeds were pre-germinated in autoclaved petri dishes containing filter paper moistened with sterile distilled water. The plates with seeds were kept in a B.O.D. incubator at 25° C. and photoperiod of 12 hours for 4 days. The germinated seeds were transferred to plastic pots containing substrate for planting and were then kept in a greenhouse for development and use for inoculation at 28 days old stage.

Plants were kept in a humid chamber for 24 hours prior to inoculation in order to favor stomata opening and, consequently, pathogen penetration. The bacterial suspension was obtained by scraping the culture medium on the petri dish with a flanged Drigalski handle, and sterile distilled water containing 0.85% NaCl (saline solution) was added. The suspension obtained was kept under stirring until complete dissolution of the colonies in the saline solution. Inoculation was performed with the aid of a spray bottle being applied to the point of dripping. Then the plants were kept in a humid chamber for additional 48 hours.

### Experimental Design for Gene Expression Analysis and Gene Array

Banana Plants were grown in fields infected with Foc TR1 or TR3 and were treated (sprayed) with TTO (in the form of Timorex Gold®, at 44 ml/L solution). The third leaf of each of the daughter plant was sampled 12 days after the third TTO application from each of the following four groups: (1) leaves from plants that did not show symptoms of Fusarium Wilt and were not treated with TTO (control and asymptomatic plants, CA); (2) leaves from plants that did not show symptoms of Fusarium Wilt and were treated with TTO (treated and asymptomatic, TA); (3) leaves from untreated plants showing symptoms of Fusarium Wilt (control and symptomatic, CS); and (4) leaves from plants treated with TTO as indicated above and showing symptoms of Fusarium Wilt (treated and symptomatic, TS). After sampling, leaves were immediately frozen in liquid nitrogen until further analysis.

Tomato plants with 5 true leaves either inoculated with Xanthomonas campestris or not inoculated and treated with TTO (in the form of Timorex Gold®, 0.5% in water, applied once) or not treated were used. The youngest fully expanded leaf was sampled at three and ten days post inoculation (dpi) from each of the following four treatment groups: (1) leaves from plants that did not show symptoms of bacterial leaf spot and were not treated with TTO (control and asymptomatic plants, CA); (2) leaves from plants that did not show symptoms of bacterial leaf spot and were treated with TTO (treated and asymptomatic, TA); (3) leaves from untreated plants showing symptoms of bacterial leaf spot (control and symptomatic, CS); and (4) leaves from plants treated with TTO as indicated above and showing symptoms of bacterial leaf spot as a result of inoculation with Xanthomonas campestris that was performed 72 hour after TTO application (treated and symptomatic, TS).

Tomato plants with 5 true leaves were divided into four groups: (1) untreated and unwounded plants; (2) plants treated with TTO (in the form of Timorex Gold®, 0.5% in water, applied once) and unwounded; (3) untreated plants mechanically wounded by stapling the youngest fully expanded leaf of the plant one time with a stapler in the absent of staples; and (4) plants pre-treated with TTO as indicated above and mechanically wounded 72 hours after TTO application. Leaf samples were taken 24 hours post wounding (hpw).

### RNA Extraction and Reverse Transcription

The sampled banana tissue (roots or leaves) were initially macerated in liquid nitrogen with the aid of autoclaved mortar and pistil and frozen until the sample was transformed into a fine powder. About 500 mg of macerated plant tissue was centrifuged, resuspended in 1500 μl extraction buffer (150 mM Tris-base, 4% SDS; 100 mM EDTA, 2% β-mercaptoethanol and 3% polyvinylpyrrolidone at pH 7.5 adjusted with saturated boric acid solution), vortexed and kept for 10 minutes in a water bath at 65° C. The samples were then carefully stirred by inversion and allowed to cool to room temperature. The contents of the tube were divided into two approximately equal parts in two separate tubes, to which 66 μl potassium acetate (5 mM) and 150 μl absolute ethanol were added. The tubes were vortexed for 1 minute. Then, 850 μL chloroform: isoamyl alcohol (49: 1; v/v) was added and the samples were vortexed again for 10 seconds. The samples were centrifuged at 12,000 g for 20 minutes at room temperature. The supernatant was recovered into a new tube and 850 μL phenol: chloroform: isoamyl alcohol (25: 24: 1; v/v/v) was added. The samples were vortexed for 10 seconds and centrifuged at 12,000 g for 15 minutes at room temperature. The supernatant was recovered into a new tube and 850 μL chloroform: isoamyl alcohol were added, vortexed for 10 seconds and centrifugation at 12,000 g for 15 minutes at 4° C. Again, the supernatant was recovered into a new tube and lithium chloride solution was added to a final concentration of 3 M. After gently swirling by inversion, the material was stored at −20° C. overnight. The samples were then centrifuged at 12,000 g for 20 minutes at 4° C. and the supernatant was discarded. The pellets were washed with 500 μl 70% ethanol twice and centrifuged at 12,000 g for 10 minutes at 4° C. after each wash. The samples were resuspended in 10 μl DEPC-treated water and stored in the ultra-freezer. RNA was spectrophotometrically quantified using NanoDrop™ spectrophotometer (Thermo Scientific).

RNA purification from tomato plants was carried out using MasterPure™ Plant RNA Purification kit (Epicentre Biotechnologies, Madison, Wis., USA), and followed by DNase I (Thermo Fisher Scientific) treatment, according to manufacturer's recommendations.

Total mRNA was reverse transcribed using oligo-dT primers in a 20 μl reaction volume using RevertAid™ First Strand cDNA Synthesis Kit (Thermo Fisher Scientific) and 1 μg total DNA-free RNA. cDNA was diluted (1:20), and 1 μl of the diluted cDNA was used in a 13 μl reaction volume containing 6.75 μl of Go-Taq® qPCR Master mix, and 0.75 μM (1 μl) of each primer.

Quantitative Real Time PCR (qPCR)

qPCR was performed in Applied Biosystem™ 7500, in triplicates under the following conditions: 95° C. for 20 seconds and 40 cycles of 95° C. for 3 seconds and 60° C. for 30 seconds. Specificity of the primers used to quantify the expression of each gene was confirmed by performing melt curve analysis, in which the temperature of the sample was gradually raised from 65° C. to 95° C. in 0.5° C. steps for 5 seconds each.

The analyzed genes relate to plant's defense pathways, such as salicylic acid (SA), ethylene (ET) and jasmonic acid (JA), normal physiological conditions, and other general defense-related genes. Arabidopsis thaliana gene sequences were obtained from TAIR (http://www.arabidopsis.org) and used for blast search of hosts (e.g., banana, tomato) orthologous genes by BLASTX® on Phytozome (http://www.phytozome.net). The sequences with the highest hit score based on identity and query cover, i.e. lowest E-value were selected for analysis. Primers were designed using Primer3Plus software (http://www.bioinformatics.nl/cgi-bin/primer3plus/primer3plus.cgi), considering the following parameters: 40-60% GC content, 18-24 nucleotides in length, annealing temperature of 60° C.±2, and 70-200 base pairs of amplicon length.

The following housekeeping genes were used for the normalization of gene expression in plants: Glyceraldehyde-3-phosphate dehydrogenase C2 (GAPC2), NAD⁺-dependent isocitrate dehydrogenase (NADP-IDH), homolog to DIM1 (YLS8), Cyclophilin (CYP) and F-box family protein (FBOX).

Table 2 lists the genes selected for gene expression analysis in banana plants and the primer sequences used in the qPCR reactions.

TABLE 2
Genes for expression analysis in banana plants and
primer sequences for qPCR reaction

| | | SEQ | | SEQ |
|---|---|---|---|---|
| | | ID | | ID |
| Gene | Forward primer sequence | NO. | Reverse primer sequence | NO. |
| NDR1 | AGACGTACGTGAGGGAGACG | 1 | ACACCTTGAGTCGCAGCTTG | 2 |
| RAR1 | GTGGTCACAGGGGAGACCTT | 3 | GGGGTAGAACTGTTGGTGGTG | 4 |
| HSP90 | TCCCCCTTCCTGGAGAGACT | 5 | AGTTTCAGCCCCTCCTTGGT | 6 |
| ICS1 | AGGCTTGTGGTAGGTCGTTG | 7 | ATCTCCTTCCCCCGAGTAAA | 8 |
| BSMT1 | GGAGATCCACAAGTAGGTGAAGC | 9 | AGTCTTGCCAGAGCAACTCG | 10 |
| NPR1 | GGAGATCCACAAGTAGGTGAAGC | 11 | AGTCTTGCCAGAGCAACTCG | 12 |
| NPR3 | GAAACCAGCCCCACAGGAC | 13 | AGTCGACGCTGTAAGAGTGAGA | 14 |
| LOX2 | AGCCACATCACCGACGACTA | 15 | GGGTGTGGAGTAGGCTCTCT | 16 |
| JAR1 | CGACTCCAGAGAGTGGTGTCA | 17 | AGCCAACCGTTCCGGTACTA | 18 |
| COI1 | GCCCAGAGACCGTGATACCT | 19 | CGGCGATAGAGTAGGGCAGA | 20 |
| JAZ | ACGGTGGAACGAGGAGTCAT | 21 | ACTGGCTCAGGAGAGTGCAG | 22 |
| MYC2 | CGGATCTACCGACGTGGTCT | 23 | AGCGTCCGGAGAGCTAAAGT | 24 |
| ERF1 | CCCAAATGTTGGTCCGTTTC | 25 | TCGCTGTCTTCCACGATTCA | 26 |
| EIN3 | GTCGTCGTCTCTCCCCTCTG | 27 | CCGGCCACTCCTACAGACTT | 28 |
| ACS | GATGCTGCACATCGGCTAGT | 29 | GCCACCTGAATACGGCAGAC | 30 |
| ET | AGGATACACAAGAAACACCCAAGAA | 31 | GACGAGACTGCGACGAGAAA | 32 |
| EDS1 | ATCTTGATTTGAGCCTGGAAGCTA | 33 | CCGGTAGTCGCTGAGAAAGC | 34 |
| PAD4 | GAACAGGTGCAACCAGCGTA | 35 | GATCCTGCCAGATCAACAAGGT | 36 |
| PR1 | TCCGGCCTTATTTCACATTC | 37 | GCCATCTTCATCATCTGCAA | 38 |
| PR2 | TCGCTGGGCTGTGGTAAGT | 39 | TCGCTGGGCTGTGGTAAGT | 40 |
| PR3 | GTCACCACCAACATCATCAA | 41 | CCAGCAAGTCGCAGTACCTC | 42 |
| PR4 | CTGTGGCAAGTGCTTGTTGG | 43 | GTAGCCAGTCCCATCGGTGT | 44 |
| PR5 | TGCTATGTTGATGAGCACGA | 45 | ACCCATCAATCAGATCACCA | 46 |

Table 3 lists the genes selected for gene expression analysis in tomato plants and the primer sequences used in the qPCR reactions.

TABLE 3
Genes for expression analysis in tomato plants and
primer sequences for qPCR reaction

| | | SEQ | | SEQ |
|---|---|---|---|---|
| | | ID | | ID |
| Gene | Forward primer sequence | NO. | Reverse primer sequence | NO. |
| NDR1 | AGCCACCTTGCTCCTCTCTT | 47 | AAGAGGCATGCAACCACTCC | 48 |
| RAR1 | TGTGCCAGCTCCTATGACCA | 49 | TTGCTTCTCTGGGTCGTGAAC | 50 |
| HSP90 | ACAAGGTTGAGAAAGTGGTGGTC | 51 | AGCCATGCTAGAGTCCCTGA | 52 |
| ICS1 | GCCCAGAACCATCTCCTCCT | 53 | GCTGAACCGACACCAGCTAC | 54 |
| BSMT1 | TCCCAGAAACATTATACATTGCTGAT | 55 | AATGACCTTAACAAGTTCTGATACCACTAA | 56 |
| NPR1 | GGTCAGTGTGCTCGCCTATT | 57 | CACAGCTGGCCTACAAGCTAC | 58 |
| NPR3 | CAGGCTTGCAGGTGTGAGAG | 59 | TCCCTCAAGAGAAAGCACAAAACT | 60 |
| LOX2 | ACTGGTAGACCACCAACACGA | 61 | ACGCTCGTCTCTCGGTACAT | 62 |
| JAR1 | TGGCTCTCTCAGGTTCCACTT | 63 | TCGTTCTGGAACTGTGACACG | 64 |
| COI1 | GCCTTTGGACCCAACTTACCTT | 65 | GGGAGGAAAAGAAGAGGCATACA | 66 |
| JAZ | CCCCACCACCACTCAGACTAA | 67 | TATGGCGCTCTAGCCGTGT | 68 |
| MYC2 | ACCACATGAAAACAAAGCTGGAC | 69 | TCTCCGCCTCTACGTGGTTT | 70 |
| ERF1 | GGGGTCCTTGGTCTCTACTCA | 71 | GTAGCTTTTAAAACAGCAGCTGGA | 72 |
| EIN3 | CAGAAGTTCGACTAGAAACGGCTAT | 73 | TCCTCTGCTCTCAAGGATACAACA | 74 |
| ACS | AGCTACGTCAATGGCAGCAC | 75 | AGGAAGGGTGGGGACTTCTG | 76 |
| ET | CCTTGCCTTACTCGTATGTTGCT | 77 | AGGGCCCTCACTCTCAATCC | 78 |
| EDS1 | GCCCTGCAAACACTACCTGT | 79 | TCAGGATAATGCCTCTGTAGAGTGT | 80 |
| PAD4 | CCAACATGTACCGCATCAAG | 81 | GGTTGTTTCGGTGGTAGTGG | 82 |
| PR1 | GGATCGGACAACGTCCTTAC | 83 | GCAACATCAAAAGGGAAATAAT | 84 |
| PR2 | TATAGCCGTTGGAAACGAAG | 85 | TGATACTTTGGCCTCTGGTC | 86 |
| PR3 | CAATTCGTTTCCAGGTTTTG | 87 | ACTTTCCGCTGCAGTATTTG | 88 |
| PR4 | GCTACCAACGTTAGGGCAAC | 89 | CTCAAGCATCTACCGCATGA | 90 |
| PRS | GAGGTTCATGCCAAACTGGTC | 91 | CCGTCAACCAAAGAAATGTCC | 92 |

The quantitation cycle (Cq) and primer efficiency were calculated from raw fluorescent data (Rn values) using Miner program Real-time PCR (http://ewindup.info/miner/) (Zhao and Fernald 2005). Relative quantification (Rq) was calculated using 2-ΔΔCq.

### Evaluation of Bacterial Leaf Spot

Evaluation of the severity of tomato bacterial stain was carried out according to the known diagrammatic scale by Mello et al., Fitopatologia Brasileira, Brasilia 22(3):447-448 (1997). After tabulating the data and calculating the severity of the disease, the area under disease progress curve (AUDPC) was calculated for assessment of the disease development over time between plants treated with TTO (in the form of Timorex Gold®, 0.5% in water, applied once) and untreated plants.

### Gene Array

RNA samples were reverse-transcribed to cDNA using routine methods. The cDNA samples were diluted 1:10 prior to use in the qRT-PCR reaction. Each diluted cDNA sample (1 μL) was pipetted three times in a 96-well plate suitable for real-time PCR readings, generating three technical repetitions for each sample. As a technical control, 0.1% diethylpyrocarbonate (DEPC)-treated water was used in three technical repetitions. Each gene of interest was studied in a different 96-well plate.

### Salicylic Acid and Jasmonic Acid Evaluation

Pepper plants were treated with water (C) or TTO (in the form of Timorex Gold®, 1 L/ha) and subjected to one of the following irrigation regimes: (1) normal, namely three times a week at varying amounts, depending on the age of the plant; or (2) drought, in which the plants received only 70% of the weekly water amount, by depriving the plants of water one day prior to each application of TTO. TTO was applied twice at weekly interval during the vegetative stage of the pepper plants (before first flower), such that the pepper plants received TTO treatment once at the age of 4 weeks and a second time at the age of 5 weeks. Sampling of the third leaf from the top was carried out a day after the second application of TTO. Hormone content in the leaf samples was analyzed.

Evaluation of the levels of salicylic acid and jasmonic acid in the leaves were carried out by a conventional method, well known in the art.

### Statistical Analysis

Statistical significance of results was determined using the Kruskal-Wallis test.

### Example 1

### TTO reduces the Incidence of Fusarium Wilt Affected Daughter Banana Plants

Results from an experiment evaluating the incidence of Fusarium Wilt-positive daughter banana plants originating from TTO- or Nativo™-treated mother plants show that Nativo™ treatment of mother banana plants resulted in 10 out 25 daughter plants (40%) being affected by Fusarium Wilt (caused by Foc TR1 or Foc TR3). However, when mother banana plants were treated with TTO, only 2 out of 25 daughter plants (8%) were affected by Fusarium Wilt.

In the 2^{nd} experiment, a first evaluation of daughter banana plants originating from treated mother plants, which was performed one year after first application of treatment, shows that treating mother banana plants with triazole-based treatment resulted in 32 out 50 daughter plants (64%) affected by Fusarium Wilt (caused by Foc TR1 or Foc TR3), while mother plants treated with a TTO-based treatment resulted in only 14 out 50 daughter plants (28%) affected by Fusarium Wilt. Moreover, a second evaluation of the daughter banana plants, which was performed after about two years from first application of the treatments, shows that 85% of daughter banana plants originating from triazole-based treatment applied to mother plants were affected by Fusarium Wilt, while only 12% of daughter plants originating from TTO-based treatment applied to mother plants were affected by the disease.

These results demonstrate that spraying of TTO on foliage of mother plants infected or exposed to FOC significantly reduces the incidence of daughter banana plants affected by Fusarium Wilt. The results also indicate that treatment of mother banana plants with TTO induces resistance to Fusarium oxysporum infection in daughter plants.

### Example 2

### TTO Pre-Treatment Induces Enzymatic Activity of Pathogenesis-Related (PR) Proteins in Banana Plants Inoculated with Fusarium oxysporum

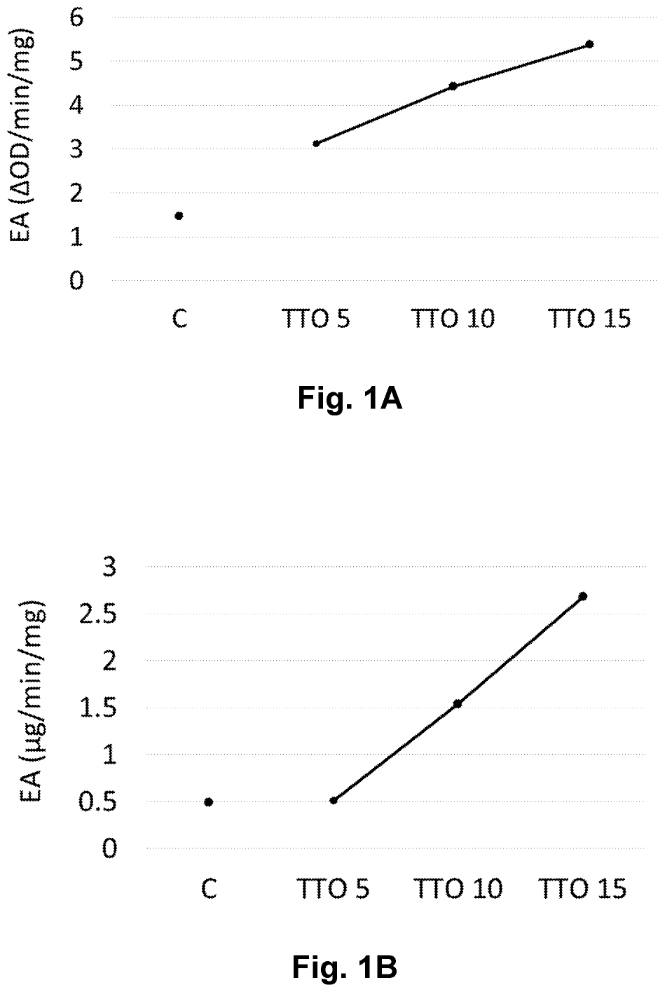

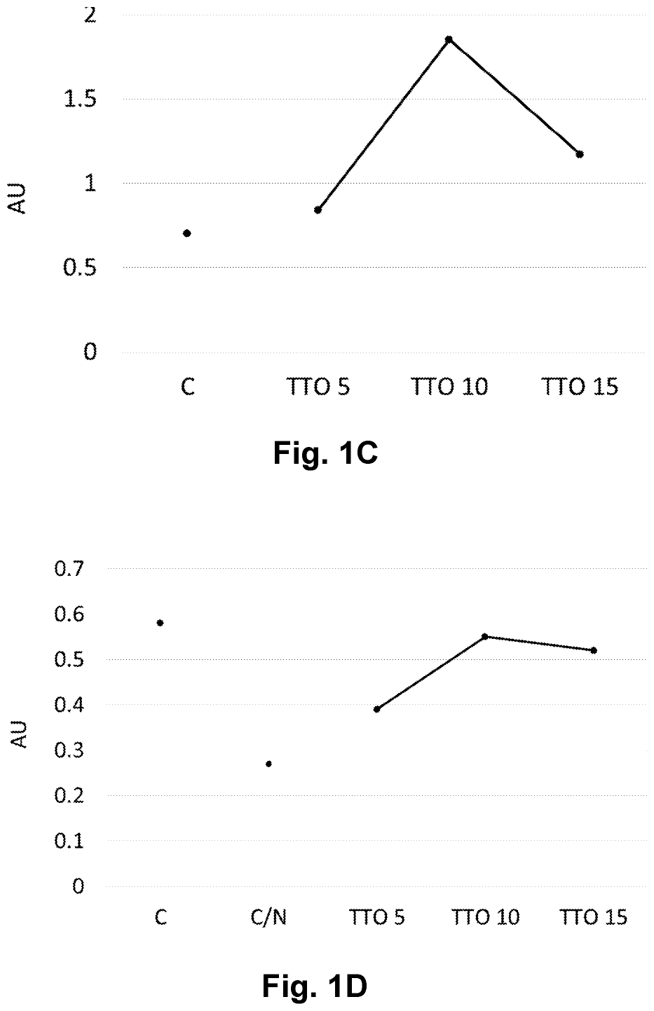

In one experiment conducted on banana plants, it was shown that pre-treatment of the plants with TTO at 5, 10 and 15 days prior to inoculation with Fusarium oxysporum (Foc TR1 or Foc TR3) significantly increased, in a time-dependent manner, the enzymatic activity of guaiacol peroxidase and β-1,3-Glucanase compared to untreated inoculated plants (FIGS. 1A and 1B, respectively). In addition, pre-treatment with TTO increased the levels of free and cell wall bound phenols in the roots compared to untreated inoculated plants (FIGS. 1C and 1 D, respectively).

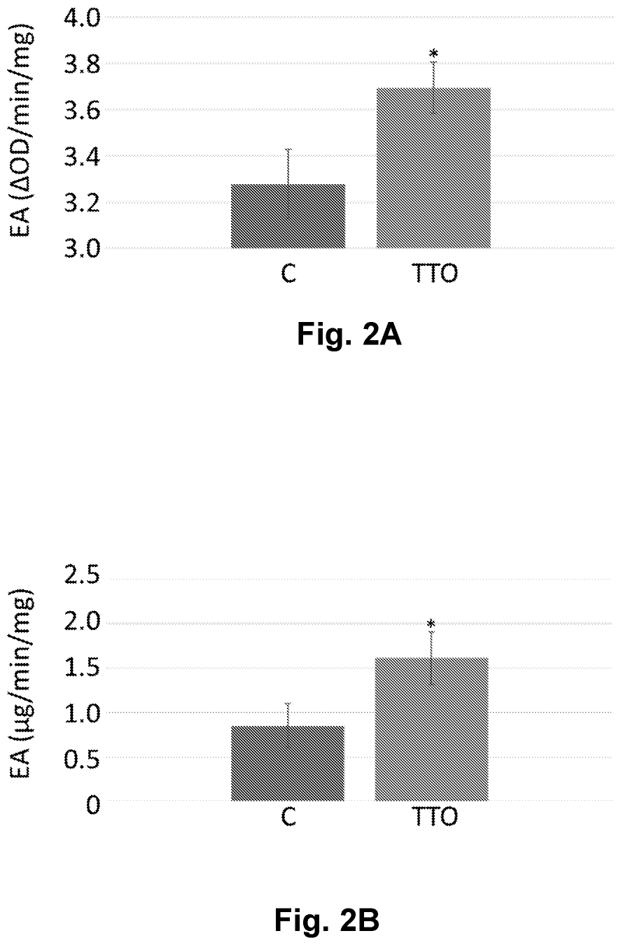

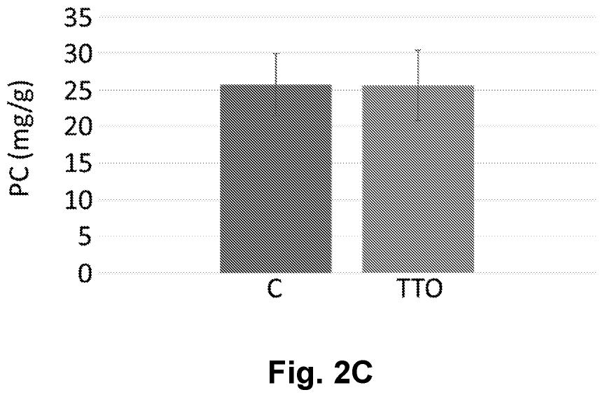

Similar results were observed in a second experiment, in which young banana plants were planted in Foc TR4-infected soil and the enzymatic activity of guaiacol peroxidase and β-1,3-Glucanase in banana plants that were treated with TTO were significantly elevated compared to the control group with no TTO treatment (FIGS. 2A and 2B, respectively). As shown in FIG. 2C, treatment with TTO did not affect the total protein content in root samples collected from banana plants, indicating that the observed increase in enzymatic activity did not result from changes in protein content.

As guaiacol peroxidase, β-1,3-Glucanase (PR-proteins) and phenol content in root samples are related to the plant's defense mechanism against pathogens, the above results indicate that TTO acts as an inducer of such defense mechanisms and of resistance of the treated plant to the pathogens.

### Example 3

### TTO Induces Resistance to Fusarium oxysporum in Banana Plants by Activating Both the Systemic Acquired Resistance (SAR) and Induced Systemic Resistance (ISR) Pathways

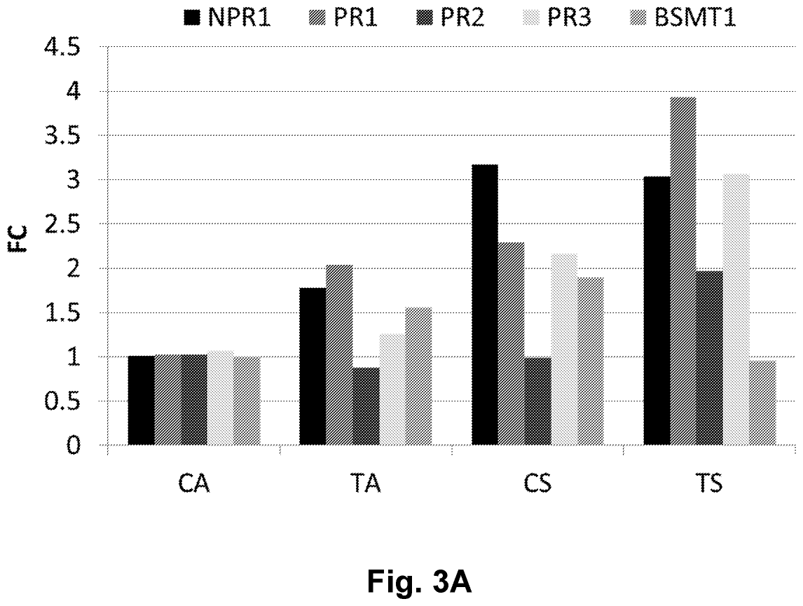

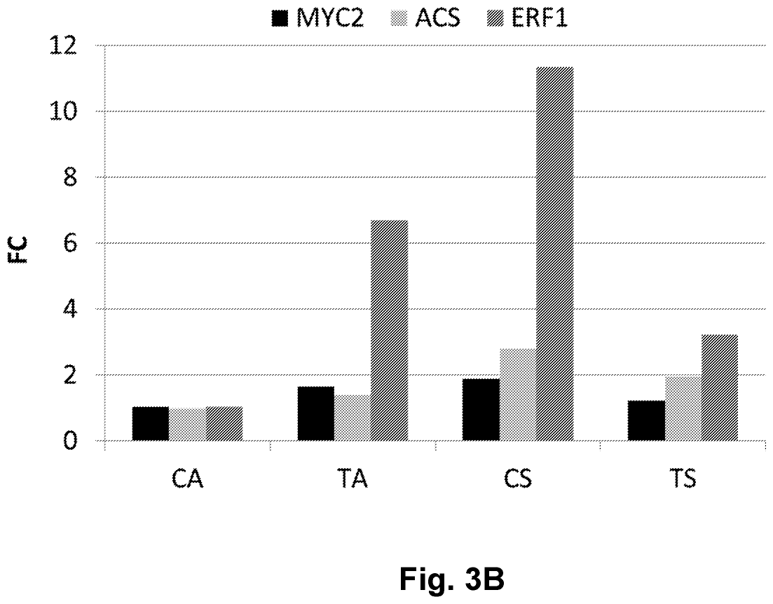

The relative expression of mRNA of genes related to the SAR pathway (NPR1, PR1, PR2, PR3 and BSMT1) and to the ISR pathway (MYC2 and ACS) in the leaves of untreated banana plants asymptomatic for Fusarium Wilt (CA), asymptomatic plants treated with TTO (TA), untreated plants symptomatic for Fusarium Wilt (CS), and plants treated with TTO and symptomatic for Fusarium Wilt (TS) was studied. As shown in FIG. 3A, treatment with TTO significantly induced the mRNA expression of NPR1, PR1 and BSMT1 in healthy (asymptomatic) banana plants. In addition, the expression of 4 out of the 5 tested SAR-related genes was induced in reaction to the infection with Fusarium oxysporum (CS group). TTO treatment of symptomatic plants further increased the expression of PR1, PR2 and PR3 compared to infected untreated (CS) plants.

TTO treatment of asymptomatic banana plants also resulted in induction of ISR-related genes, such as MYC2, ACS and ERF1 (FIG. 3B). As expected, the plants that were infected with Fusarium oxysporum (CS) showed prominent symptoms of Fusarium Wilt, and some of the tested defense-related genes were upregulated by the infection, since the plants were destroyed by the fungal colonization and the plant recognized damage-associated molecular patterns (DAMPS) that, in turn, activate the defense reaction. However, TTO treatment of infected plants (TS) caused changes in the response pattern. The genes PR1, PR2 and PR3 that encode for pathogenesis-related proteins were highly overexpressed as a result of the TTO treatment in the TS groups of plants compared to untreated CS group of plants.

These results demonstrate that TTO is an efficient resistance inducer, since it enhances the expression of marker genes in banana plants for both SAR and ISR pathways, via the three main defense related pathways, namely, salicylic acid-, jasmonic acid- and ethylene-mediated pathways.

### Example 4

### TTO Induces Resistance to Xanthomonas campestris in Tomato Plants by Activating Both the Systemic Acquired Resistance (SAR) and Induced Systemic Resistance (ISR) Pathways

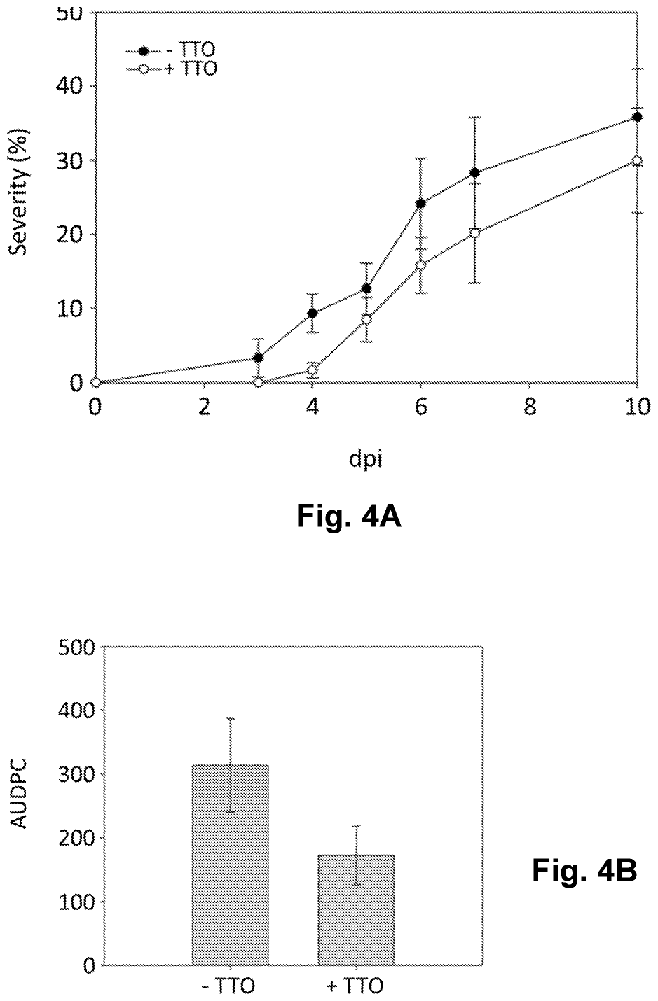

As shown in FIGS. 4A and 4B treatment of tomato plants with TTO alleviates the severity of the bacterial leaf spot in plants inoculated with Xanthomonas campestris.

A gene array analysis performed on leaf samples from tomato plants show that TTO pre-treatment in asymptomatic (TA) tomato plants led to the induction of the expression of genes related to the resistance pathways, such as R-genes (HCR2 and CCNBS) and other genes related to the SAR pathway (WRKY transcription factor, NPR1, PR1 and PR2) and the ISR pathways, (JAZ1, LOX2, MYC2, ACS, ERF1 and EIN3). The overexpression of these resistance-mediating genes was even stronger in TTO-treated plants showing symptoms of bacterial leaf spot at 3 days post inoculated with Xanthomonas campestris (TS). Xanthomonas campestris inoculation by itself (namely, without treatment with TTO) did not show any significant overexpression of the above-mentioned genes at 3 dpi. In Fact, the expression of NPR1, ERF1 and EIN was downregulated as a result of the bacterial infection at this time point. The bacterial infection led to an up-regulation of several genes (mainly R-genes and ISR-associated genes) at 10 dpi. This is probably because at this time point the infection was robust enough for the plant to recognize the pathogen and the bacterial-induced damage to the plant. Still, TTO pre-treatment of plants showing bacterial leaf spot was even greater, including overexpression of SAR-related genes. This overexpression was also greater than the gene induction observed at 3 dpi in infected plants treated with TTO. The effect of TTO in asymptomatic plants at 10 dpi was not as strong as at 3 dpi, indicating a negative feedback mechanism.

Furthermore, TTO treatment showed overexpression of genes related to phenylpropanoids metabolites.

### Example 5

### TTO Primes Tomato Plants to have a Defense Reaction to a Subsequent Challenge

A gene array analysis performed on leaf samples from tomato plants show that a mechanical wound inflicted to the plants led to an induction of R-genes (HCR2 and CCNBS) and genes related to the ISR pathway (JAZ1, LOX2, MYC2, ACS, ERF1 and EIN3) at 24 hours post wounding (hpw). TTO pre-treatment of the wounded plants demonstrated a strong overexpression of SAR-related genes (WRKY transcription factor, NPR1, PR1 and PR2) in addition to the induction of R-genes and ISR-related genes. These results indicate that TTO is able to prime tomato plants to have a strong defense reaction to subsequent challenges, such as mechanical wounding. These results also demonstrate that TTO provides protection to the plant independent of the fungicidal effect.

### Example 6

### TTO Elevates Levels of Salicylic Acid and Jasmonic Acid in Pepper Plants

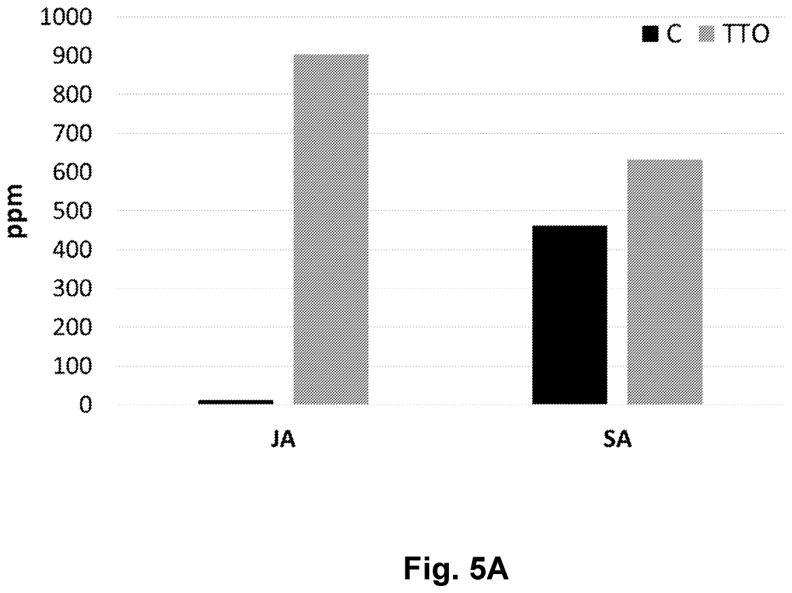

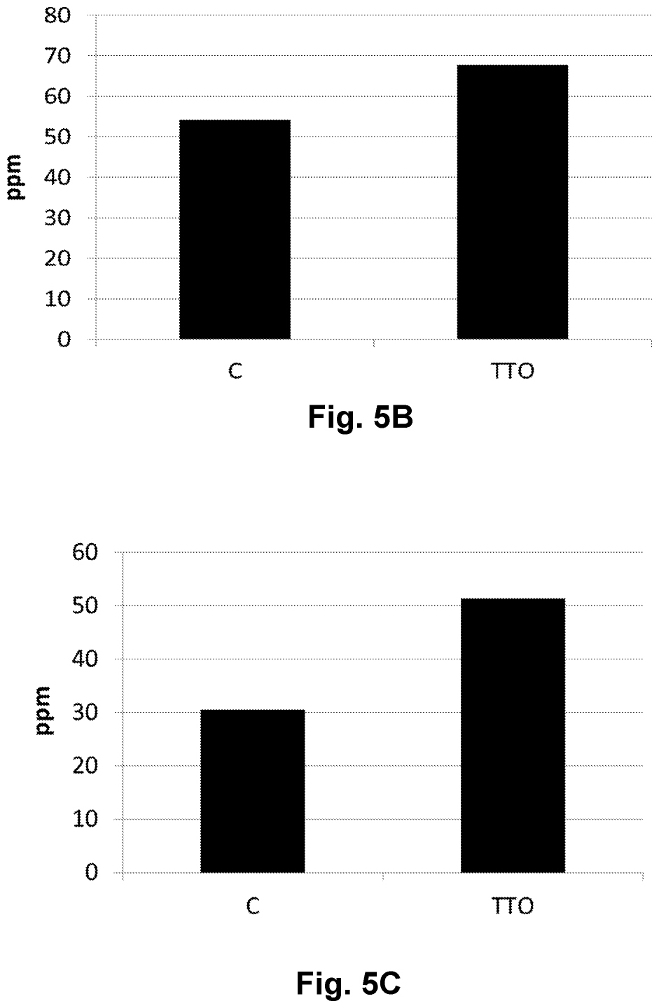

An evaluation of the levels of hormones in leaves from pepper plants 1 day after application of TTO compared to untreated plants shows significant alterations in the levels of 9 out of the 34 detected hormones. The levels of jasmonic acid (JA), jasmonoyl isoleucine (JA-Ile), (−)-dihydrophaseic acid (DPA), and salicylic acid were elevated by the treatment of TTO. The levels of indole-3-aldehyde (IAld), gibberellic acid 8 (GA8) and abscisic acid (ABA) were reduced by TTO treatment. As shown in FIG. 5A, the levels of salicylic acid in leaf samples from pepper plants at the vegetative state grown under normal irrigation were slightly increased by the treatment with TTO. By contrast, the levels of jasmonic acid were markedly elevated by TTO.

In an experiment evaluating the levels of salicylic acid in pepper plants grown under drought conditions compared to normal irrigation, it was shown that under normal condition, TTO treatment elevated the levels of salicylic acid by 25% compared to untreated plants (FIG. 5B). However, the levels of salicylic acid increased by 68% in TTO-treated pepper plants grown under drought conditions compared to untreated plants (FIG. 5C).

These results indicate that TTO is able to prime pepper plants to have a strong defense reaction to a challenge, such as drought.

1. A method for inducing defense response in a plant, comprising applying to a plant or a plant part, a composition comprising tea tree oil (TTO) or components thereof.

2. The method according to claim 1, wherein the defense response is local or systemic acquired resistance (SAR).

3. The method according to claim 1, wherein the defense response is induced systemic resistance (ISR).

4. The method according to claim 1, wherein the defense response includes both induced systemic resistance (ISR) and local or systemic acquired resistance (SAR).

5. The method according to claim 1, wherein the defense response comprises induction of resistance imparting genes, overexpression of plant defense hormones, elevation of phenols and phenylpropanoids, and/or enhancement of pathogenesis related (PR) proteins enzymatic activity.

6. The method according to claim 5, wherein the plant defense hormones are selected from Salicylic acid (SA), Methyl salicylate (MeSA), Jasmonic acid (JA), Ethylene (ET), 1-aminoacyclopropane-1-carboxylate (ACC), jasmonoyl isoleucine (JA-Ile), and (−)-dihydrophaseic acid (DPA).

7. The method according to claim 5, wherein the resistance imparting genes are selected from salicylate/benzoate carboxyl methyltransferase (BSMT1), nonrace-specific disease resistance protein 1 (NDR1), Rar1, heat shock protein 90 (HSP90), Enhanced disease susceptibility 1 (EDS1), EDS 5, Isochorismate synthase 1 (ICS1), ICS2, salicylic acid glucosyltransferase (UGT74F), methyl salicylate esterase (AtMES), phenylalanine ammonia-lyase (PAL), Salicylate/benzoate carboxyl methyltransferase (BSMT1), Non-expressor of PR1 (NPR1), Non-expressor of PR3 (NPR3), Pathogenesis-related protein 1 (PR1), Pathogenesis-related protein 2 (PR2), Pathogenesis-related protein 3 (PR3), Pathogenesis-related protein 4 (PR4), Phytoalexin Deficient 4 (PAD4), Senescence Associate Gene 101 (SAG101), TGACG motif binding transcription factors (TGA factors), WRKY transcription factors, 1-aminocyclopropane-1-carboxylate synthase (ACS), ACC oxidase (ACO), galactolipase/phospholipase A1 (DAD1), galactolipase (DGL), 13-Lipoxygenase (LOX2), allene oxide synthase (AOS), allene oxide cyclase (AOC), 12-oxo-phytodienoic acid reductase (OPR3), 3-oxo-2-[(Z)pent-2′-enyl]-cyclopentan-1 -octanoic acid-Coenzyme A ligase (OPCL1), acyl-Coenzyme A oxidase (ACX), jasmonic acid-amino acid synthase (JAR1), jasmonic acid carboxyl methyltransferase (JMT), hydroxyjasmonic acid sulfotransferase (AtST2a), Coronatine-insensitive protein 1 (COI1), jasmonate-zim-domain protein 1 (JAZ1), bHLHzip transcription factor MYC2 (MYC2), Ethylene response factor 1 (ERF1), and Ethylene insensitive 3 (EIN3), HCR2, CCNBS, TIR-NBS, RRL, and RESIS.

8. The method according to claim 1, wherein the inducing of defense response comprises the priming of the resistance mechanisms of the plant.

9. The method according to claim 1, wherein the defense response is activated in the event of an attack by a pathogen or pest.

10. The method according to claim 9, wherein the pathogen or pest is a fungus, an oomycete, a bacterium, a virus, an insect, protozoa, a nematode or an acarus.

11. The method according to claim 1, wherein the defense response is activated in the event of abiotic stress.

12. The method according to claim 11, wherein the abiotic stress is drought, wounding, mechanical wounding, cold exposure, heat exposure, osmotic stress, UV light exposure, flooding, increased soil salinity, increased mineral exposure, ozone exposure, high light exposure, or limited availability of nutrients.

13. The method according to claim 1, wherein TTO is applied to the plant or plant part before or after exposure of the plant to a biotic or abiotic stress, or to an asymptomatic plant or a plant showing a symptom of stress or disease.

14. The method according to claim 1, wherein TTO or a composition comprising TTO or components thereof is applied to the plant by drenching, foliar or soil spraying, dipping, watering, aerial or drip irrigating, evaporating, dusting, fogging, foaming, spreading-on, or injecting.

15. The method according to claim 1, wherein the inducing of defense response in the plant results in a stronger and faster induction of the expression of plant defense genes in the event of biotic or abiotic stress, as compared to non-treated plants.

16. A method of inducing expression of defense genes in a plant or a plant part, comprising applying to the plant or the plant part, a composition comprising tea tree oil (TTO) or components thereof.

17. A method of activating salicylic acid (SA)-, jasmonic acid (JA)-, and/or ethylene-mediated resistance, in a plant or a plant part, comprising applying to the plant or the plant part a composition comprising tea tree oil (TTO) or components thereof.

18. The method according to claim 1, wherein TTO is applied in combination with at least one additional compound, selected from the group consisting of a plant growth regulator, a plant nutrient, a pesticide, an insecticide, a fungicide, a bactericide, a herbicide, an acaricide, and a nematicide.

19. The method according to claim 16, wherein TTO is applied in combination with at least one additional compound, selected from the group consisting of a plant growth regulator, a plant nutrient, a pesticide, an insecticide, a fungicide, a bactericide, an herbicide, an acaricide, and a nematicide.

20. The method according to claim 17, wherein TTO is applied in combination with at least one additional compound, selected from the group consisting of a plant growth regulator, a plant nutrient, a pesticide, an insecticide, a fungicide, a bactericide, an herbicide, an acaricide, and a nematicide.


SEQUENCE LISTING (92 sequences)

SEQ ID NO: 1 - DNA, 20 bp, Artificial Sequence
  NDR1 forward qPCR primer (in banana)
agacgtacgtgagggagacg

SEQ ID NO: 2 - DNA, 20 bp, Artificial Sequence
  NDR1 reverse qPCR primer (in banana)
acaccttgagtcgcagcttg

SEQ ID NO: 3 - DNA, 20 bp, Artificial Sequence
  RAR1 forward qPCR primer (in banana)
gtggtcacaggggagacctt

SEQ ID NO: 4 - DNA, 21 bp, Artificial Sequence
  RAR1 reverse qPCR primer (in banana)
ggggtagaactgttggtggtg

SEQ ID NO: 5 - DNA, 20 bp, Artificial Sequence
  HSP90 forward qPCR primer (in banana)
tcccccttcctggagagact

SEQ ID NO: 6 - DNA, 20 bp, Artificial Sequence
  HSP90 reverse qPCR primer (in banana)
agtttcagcccctccttggt

SEQ ID NO: 7 - DNA, 20 bp, Artificial Sequence
  ICS1 forward qPCR primer (in banana)
aggcttgtggtaggtcgttg

SEQ ID NO: 8 - DNA, 20 bp, Artificial Sequence
  ICS1 reverse qPCR primer (in banana)
atctccttcccccgagtaaa

SEQ ID NO: 9 - DNA, 23 bp, Artificial Sequence
  BSMT1 forward qPCR primer (in banana)
ggagatccacaagtaggtgaagc

SEQ ID NO: 10 - DNA, 20 bp, Artificial Sequence
  BSMT1 reverse qPCR primer (in banana)
agtcttgccagagcaactcg

SEQ ID NO: 11 - DNA, 23 bp, Artificial Sequence
  NPR1 forward qPCR primer (in banana)
ggagatccacaagtaggtgaagc

SEQ ID NO: 12 - DNA, 20 bp, Artificial Sequence
  NPR1 reverse qPCR primer (in banana)
agtcttgccagagcaactcg

SEQ ID NO: 13 - DNA, 19 bp, Artificial Sequence
  NPR3 forward qPCR primer (in banana)
gaaaccagccccacaggac

SEQ ID NO: 14 - DNA, 22 bp, Artificial Sequence
  NPR3 reverse qPCR primer (in banana)
agtcgacgctgtaagagtgaga

SEQ ID NO: 15 - DNA, 20 bp, Artificial Sequence
  LOX2 forward qPCR primer (in banana)
agccacatcaccgacgacta

SEQ ID NO: 16 - DNA, 20 bp, Artificial Sequence
  LOX2 reverse qPCR primer (in banana)
gggtgtggagtaggctctct

SEQ ID NO: 17 - DNA, 21 bp, Artificial Sequence
  JAR1 forward qPCR primer (in banana)
cgactccagagagtggtgtca

SEQ ID NO: 18 - DNA, 20 bp, Artificial Sequence
  JAR1 reverse qPCR primer (in banana)
agccaaccgttccggtacta

SEQ ID NO: 19 - DNA, 20 bp, Artificial Sequence
  COI1 forward qPCR primer (in banana)
gcccagagaccgtgatacct

SEQ ID NO: 20 - DNA, 20 bp, Artificial Sequence
  COI1 reverse qPCR primer (in banana)
cggcgatagagtagggcaga

SEQ ID NO: 21 - DNA, 20 bp, Artificial Sequence
  JAZ forward qPCR primer (in banana)
acggtggaacgaggagtcat

SEQ ID NO: 22 - DNA, 20 bp, Artificial Sequence
  JAZ reverse qPCR primer (in banana)
actggctcaggagagtgcag

SEQ ID NO: 23 - DNA, 20 bp, Artificial Sequence
  MYC2 forward qPCR primer (in banana)
cggatctaccgacgtggtct

SEQ ID NO: 24 - DNA, 20 bp, Artificial Sequence
  MYC2 reverse qPCR primer (in banana)
agcgtccggagagctaaagt

SEQ ID NO: 25 - DNA, 20 bp, Artificial Sequence
  ERF1 forward qPCR primer (in banana)
cccaaatgttggtccgtttc

SEQ ID NO: 26 - DNA, 20 bp, Artificial Sequence
  EIN3 forward qPCR primer (in banana)
tcgctgtcttccacgattca

SEQ ID NO: 27 - DNA, 20 bp, Artificial Sequence
  EIN3 forward qPCR primer (in banana)
gtcgtcgtctctcccctctg

SEQ ID NO: 28 - DNA, 20 bp, Artificial Sequence
  EIN3 reverse qPCR primer (in banana)
ccggccactcctacagactt

SEQ ID NO: 29 - DNA, 20 bp, Artificial Sequence
  ACS forward qPCR primer (in banana)
gatgctgcacatcggctagt

SEQ ID NO: 30 - DNA, 20 bp, Artificial Sequence
  ACS reverse qPCR primer (in banana)
gccacctgaatacggcagac

SEQ ID NO: 31 - DNA, 25 bp, Artificial Sequence
  ET forward qPCR primer (in banana)
aggatacacaagaaacacccaagaa

SEQ ID NO: 32 - DNA, 20 bp, Artificial Sequence
  ET reverse qPCR primer (in banana)
gacgagactgcgacgagaaa

SEQ ID NO: 33 - DNA, 24 bp, Artificial Sequence
  EDS1 forward qPCR primer (in banana)
atcttgatttgagcctggaagcta

SEQ ID NO: 34 - DNA, 20 bp, Artificial Sequence
  EDS1 reverse qPCR primer (in banana)
ccggtagtcgctgagaaagc

SEQ ID NO: 35 - DNA, 20 bp, Artificial Sequence
  PAD4 forward qPCR primer (in banana)
gaacaggtgcaaccagcgta

SEQ ID NO: 36 - DNA, 22 bp, Artificial Sequence
  PAD4 reverse qPCR primer (in banana)
gatcctgccagatcaacaaggt

SEQ ID NO: 37 - DNA, 20 bp, Artificial Sequence
  PR1 forward qPCR primer (in banana)
tccggccttatttcacattc

SEQ ID NO: 38 - DNA, 20 bp, Artificial Sequence
  PR1 reverse qPCR primer (in banana)
gccatcttcatcatctgcaa

SEQ ID NO: 39 - DNA, 19 bp, Artificial Sequence
  PR2 forward qPCR primer (in banana)
tcgctgggctgtggtaagt

SEQ ID NO: 40 - DNA, 19 bp, Artificial Sequence
  PR2 reverse qPCR primer (in banana)
tcgctgggctgtggtaagt

SEQ ID NO: 41 - DNA, 20 bp, Artificial Sequence
  PR3 forward qPCR primer (in banana)
gtcaccaccaacatcatcaa

SEQ ID NO: 42 - DNA, 20 bp, Artificial Sequence
  PR3 reverse qPCR primer (in banana)
ccagcaagtcgcagtacctc

SEQ ID NO: 43 - DNA, 20 bp, Artificial Sequence
  PR4 forward qPCR primer (in banana)
ctgtggcaagtgcttgttgg

SEQ ID NO: 44 - DNA, 20 bp, Artificial Sequence
  PR4 reverse qPCR primer (in banana)
gtagccagtcccatcggtgt

SEQ ID NO: 45 - DNA, 20 bp, Artificial Sequence
  PR5 forward qPCR primer (in banana)
tgctatgttgatgagcacga

SEQ ID NO: 46 - DNA, 20 bp, Artificial Sequence
  PR5 reverse qPCR primer (in banana)
acccatcaatcagatcacca

SEQ ID NO: 47 - DNA, 20 bp, Artificial Sequence
  NDR1 forward qPCR primer (in tomato)
agccaccttgctcctctctt

SEQ ID NO: 48 - DNA, 20 bp, Artificial Sequence
  NDR1 reverse qPCR primer (in tomato)
aagaggcatgcaaccactcc

SEQ ID NO: 49 - DNA, 20 bp, Artificial Sequence
  RAR1 forward qPCR primer (in tomato)
tgtgccagctcctatgacca

SEQ ID NO: 50 - DNA, 21 bp, Artificial Sequence
  RAR1 reverse qPCR primer (in tomato)
ttgcttctctgggtcgtgaac

SEQ ID NO: 51 - DNA, 23 bp, Artificial Sequence
  HSP90 forward qPCR primer (in tomato)
acaaggttgagaaagtggtggtc

SEQ ID NO: 52 - DNA, 20 bp, Artificial Sequence
  HSP90 reverse qPCR primer (in tomato)
agccatgctagagtccctga

SEQ ID NO: 53 - DNA, 20 bp, Artificial Sequence
  ICS1 forward qPCR primer (in tomato)
gcccagaaccatctcctcct

SEQ ID NO: 54 - DNA, 20 bp, Artificial Sequence
  ICS1 reverse qPCR primer (in tomato)
gctgaaccgacaccagctac

SEQ ID NO: 55 - DNA, 26 bp, Artificial Sequence
  BSMT1 forward qPCR primer (in tomato)
tcccagaaacattatacattgctgat

SEQ ID NO: 56 - DNA, 30 bp, Artificial Sequence
  BSMT1 reverse qPCR primer (in tomato)
aatgaccttaacaagttctgataccactaa

SEQ ID NO: 57 - DNA, 20 bp, Artificial Sequence
  NPR1 forward qPCR primer (in tomato)
ggtcagtgtgctcgcctatt

SEQ ID NO: 58 - DNA, 21 bp, Artificial Sequence
  NPR1 reverse qPCR primer (in tomato)
cacagctggcctacaagctac

SEQ ID NO: 59 - DNA, 20 bp, Artificial Sequence
  NPR3 forward qPCR primer (in tomato)
caggcttgcaggtgtgagag

SEQ ID NO: 60 - DNA, 24 bp, Artificial Sequence
  NPR3 reverse qPCR primer (in tomato)
tccctcaagagaaagcacaaaact

SEQ ID NO: 61 - DNA, 21 bp, Artificial Sequence
  LOX2 forward qPCR primer (in tomato)
actggtagaccaccaacacga

SEQ ID NO: 62 - DNA, 20 bp, Artificial Sequence
  LOX2 reverse qPCR primer (in tomato)
acgctcgtctctcggtacat

SEQ ID NO: 63 - DNA, 21 bp, Artificial Sequence
  JAR1 forward qPCR primer (in tomato)
tggctctctcaggttccactt

SEQ ID NO: 64 - DNA, 21 bp, Artificial Sequence
  JAR1 reverse qPCR primer (in tomato)
tcgttctggaactgtgacacg

SEQ ID NO: 65 - DNA, 22 bp, Artificial Sequence
  COI1 forward qPCR primer (in tomato)
gcctttggacccaacttacctt

SEQ ID NO: 66 - DNA, 23 bp, Artificial Sequence
  COI1 reverse qPCR primer (in tomato)
gggaggaaaagaagaggcataca

SEQ ID NO: 67 - DNA, 21 bp, Artificial Sequence
  JAZ forward qPCR primer (in tomato)
ccccaccaccactcagactaa

SEQ ID NO: 68 - DNA, 19 bp, Artificial Sequence
  JAZ reverse qPCR primer (in tomato)
tatggcgctctagccgtgt

SEQ ID NO: 69 - DNA, 23 bp, Artificial Sequence
  MYC2 forward qPCR primer (in tomato)
accacatgaaaacaaagctggac

SEQ ID NO: 70 - DNA, 20 bp, Artificial Sequence
  MYC2 reverse qPCR primer (in tomato)
tctccgcctctacgtggttt

SEQ ID NO: 71 - DNA, 21 bp, Artificial Sequence
  ERF1 forward qPCR primer (in tomato)
ggggtccttggtctctactca

SEQ ID NO: 72 - DNA, 24 bp, Artificial Sequence
  ERF1 reverse qPCR primer (in tomato)
gtagcttttaaaacagcagctgga

SEQ ID NO: 73 - DNA, 25 bp, Artificial Sequence
  EIN3 forward qPCR primer (in tomato)
cagaagttcgactagaaacggctat

SEQ ID NO: 74 - DNA, 24 bp, Artificial Sequence
  EIN3 reverse qPCR primer (in tomato)
tcctctgctctcaaggatacaaca

SEQ ID NO: 75 - DNA, 20 bp, Artificial Sequence
  ACS forward qPCR primer (in tomato)
agctacgtcaatggcagcac

SEQ ID NO: 76 - DNA, 20 bp, Artificial Sequence
  ACS reverse qPCR primer (in tomato)
aggaagggtggggacttctg

SEQ ID NO: 77 - DNA, 23 bp, Artificial Sequence
  ET forward qPCR primer (in tomato)
ccttgccttactcgtatgttgct

SEQ ID NO: 78 - DNA, 20 bp, Artificial Sequence
  ET reverse qPCR primer (in tomato)
agggccctcactctcaatcc

SEQ ID NO: 79 - DNA, 20 bp, Artificial Sequence
  EDS1 forward qPCR primer (in tomato)
gccctgcaaacactacctgt

SEQ ID NO: 80 - DNA, 25 bp, Artificial Sequence
  EDS1 reverse qPCR primer (in tomato)
tcaggataatgcctctgtagagtgt

SEQ ID NO: 81 - DNA, 20 bp, Artificial Sequence
  PAD4 forward qPCR primer (in tomato)
ccaacatgtaccgcatcaag

SEQ ID NO: 82 - DNA, 20 bp, Artificial Sequence
  PAD4 reverse qPCR primer (in tomato)
ggttgtttcggtggtagtgg

SEQ ID NO: 83 - DNA, 20 bp, Artificial Sequence
  PR1 forward qPCR primer (in tomato)
ggatcggacaacgtccttac

SEQ ID NO: 84 - DNA, 22 bp, Artificial Sequence
  PR1 reverse qPCR primer (in tomato)
gcaacatcaaaagggaaataat

SEQ ID NO: 85 - DNA, 20 bp, Artificial Sequence
  PR2 forward qPCR primer (in tomato)
tatagccgttggaaacgaag

SEQ ID NO: 86 - DNA, 20 bp, Artificial Sequence
  PR2 reverse qPCR primer (in tomato)
tgatactttggcctctggtc

SEQ ID NO: 87 - DNA, 20 bp, Artificial Sequence
  PR3 forward qPCR primer (in tomato)
caattcgtttccaggttttg

SEQ ID NO: 88 - DNA, 20 bp, Artificial Sequence
  PR3 reverse qPCR primer (in tomato)
actttccgctgcagtatttg

SEQ ID NO: 89 - DNA, 20 bp, Artificial Sequence
  PR4 forward qPCR primer (in tomato)
gctaccaacgttagggcaac

SEQ ID NO: 90 - DNA, 20 bp, Artificial Sequence
  PR4 reverse qPCR primer (in tomato)
ctcaagcatctaccgcatga

SEQ ID NO: 91 - DNA, 21 bp, Artificial Sequence
  PR5 forward qPCR primer (in tomato)
gaggttcatgccaaactggtc

SEQ ID NO: 92 - DNA, 21 bp, Artificial Sequence
  PR5 reverse qPCR primer (in tomato)
ccgtcaaccaaagaaatgtcc